(19) United States
(12) Patent Application Publication
(10) Pub. No.: US 2026/0353190 A1
(43) Pub. Date: Nov. 5, 2026

(54) CLIENT PREFERENCES SIGNALING FOR BUFFERED DOWNLINK DATA DELIVERY DURING SEAMLESS ROAMING

(71) Applicant: Cisco Technology, Inc., San Jose, CA (US)

(72) Inventors: Binita Gupta, San Diego, CA (US); Brian D. Hart, Sunnyvale, CA (US)

(73) Assignee: Cisco Technology, Inc., San Jose, CA (US)

(21) Appl. No.: 19/735,351

(22) Filed: Jul. 8, 2026

Related U.S. Application Data
(63) Continuation of application No. 19/543,750, filed on Feb. 18, 2026.
(60) Provisional application No. 63/759,917, filed on Feb. 18, 2025.
(60) Provisional application No. 63/765,135, filed on Feb. 28, 2025.
(60) Provisional application No. 63/890,831, filed on Sep. 30, 2025.

(51) Int. Cl. H04W 28/10; H04W 8/12

(52) U.S. Cl. CPC H04W 28/10; H04W 8/12

(57) ABSTRACT

Client preferences signaling for buffered downlink (DL) data delivery during seamless roaming may be provided. A serving access point (AP) receives a roaming request from a client device, the roaming request indicating an intent to roam from the serving AP to a target AP and including one or more preferences for handling buffered DL data at the serving AP. The serving AP sends a roaming response to the client device, the roaming response indicating parameters for delivering buffered DL data based on the one or more preferences. The serving AP then participates in a buffered DL data delivery phase with the client device based on the parameters indicated in the roaming response, including delivering at least a first portion of the buffered DL data to the client device or forwarding at least a second portion of the buffered DL data to the target AP

### RELATED APPLICATION

This application is a continuation of U.S. patent application Ser. No. 19/543,750, filed Feb. 18, 2026, which claims the benefit of and priority to U.S. Provisional Application No. 63/759,917, filed Feb. 18, 2025, U.S. Provisional Application No. 63/765,135, filed Feb. 28, 2025, and U.S. Provisional Application No. 63/890,831, filed Sep. 30, 2025.

### TECHNICAL FIELD

The present disclosure relates generally to providing client preferences signaling for buffered downlink data delivery during seamless roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for client preferences signaling for buffered downlink (DL) data delivery during seamless roaming in accordance with aspects of the present disclosure.

FIG. 2 illustrates a seamless roaming process in accordance with aspects of the present disclosure.

FIG. 3 is a message exchange diagram illustrating a procedure for client preferences signaling for buffered DL data delivery during seamless roaming in accordance with aspects of the present disclosure.

FIG. 4 is a block diagram illustrating an example seamless mobility domain (SMD) information element for DL data forwarding in accordance with aspects of the present disclosure.

FIG. 5 is a block diagram illustrating an example SMD basic service set transition (ST) info field in an ST execution request for DL data forwarding in accordance with aspects of the present disclosure.

FIG. 6 is a block diagram illustrating an example ST info field in an ST execution response for DL data forwarding in accordance with aspects of the present disclosure.

FIG. 7 is a block diagram illustrating an example ST info field in an ST execution request for DL data drain in accordance with aspects of the present disclosure.

FIG. 8 is a flow diagram illustrating a method for client preferences signaling for buffered DL data delivery during seamless roaming in accordance with aspects of the present disclosure.

FIG. 9 is a block diagram of a computing device in accordance with aspects of the present disclosure.

FIG. 10 is a block diagram of a communications device in accordance with aspects of the present disclosure.

### DETAILED DESCRIPTION

### Overview

Client preferences signaling for buffered downlink (DL) data delivery during seamless roaming may be provided. A serving access point (AP) receives a roaming request from a client device, the roaming request indicating an intent to roam from the serving AP to a target AP and including one or more preferences for handling buffered DL data at the serving AP. The serving AP sends a roaming response to the client device, the roaming response indicating parameters for delivering buffered DL data based on the one or more preferences. The serving AP then participates in a buffered DL data delivery phase with the client device based on the parameters indicated in the roaming response, including delivering at least a first portion of the buffered DL data to the client device or forwarding at least a second portion of the buffered DL data to the target AP.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Roaming in Wi-Fi networks occurs when a client device (e.g., a Station (STA), a non-Access Point Multi-Link Device (non-AP MLD)) transitions its connection from one Access Point (AP) (e.g., an AP MLD) to another AP, typically because the client device has moved outside the range of its serving AP or has identified another AP that can provide a better connection. Roaming decisions are primarily made by client devices based on Received Signal Strength Indicator (RSSI) measurements, supplemented by network recommendations from the serving AP regarding suitable neighbor APs.

Seamless roaming techniques have been developed to reduce roaming latency and improve user experience during AP transitions. Non-Multi-Link Device (MLD) seamless roaming techniques include those described in IEEE 802.11k, which reduce the time required to roam by enabling a client to more quickly determine which AP it should roam to next, with the serving AP providing information regarding neighboring APs and their channels. Another non-MLD technique is described in IEEE 802.11r, which uses Fast Basic Service Set (BSS) Transition (FT) to allow encryption keys to be stored on all of the APs in a network, enabling a client device to avoid performing the complete authentication process to a backend server every time it roams to a new AP within the network, thus reducing authentication-related latency.

MLD-based seamless roaming as defined in the IEEE 802.11bn amendment introduces Seamless Mobility Domains (SMDs), which are logical, secure groupings of multiple AP MLDs that enable client devices to roam between them without disconnecting, re-authenticating, re-associating, or experiencing packet loss. MLD-based seamless roaming (also referred to as SMD roaming or SMD BSS transition (ST)) enables a “make-before-break” approach where a device establishes a connection to a new AP MLD before releasing the old one by utilizing multiple links. This allows the client device to maintain connectivity during the transition, as the client can communicate with both the serving AP MLD and the target AP MLD simultaneously over different links. The IEEE 802.11bn seamless roaming procedures include a roaming preparation phase during which the client device and serving AP exchange signaling to prepare one or more target APs for the upcoming roaming, followed by a roaming execution phase during which the actual transition to the target AP occurs. The roaming preparation phase may include negotiation of target APs, establishment of security associations with target APs, and preparation of link configurations, enabling the subsequent roaming execution to occur with minimal latency and data loss.

To achieve lossless roaming performance, IEEE 802.11bn defines mechanisms for handling buffered downlink (DL) data during the roaming transition. Two primary mechanisms exist for managing this buffered DL data. First, a DL data draining mode is defined wherein the client device can fetch buffered DL data from the current serving AP MLD for a specified time period (buffered DL data delivery period), even after it has roaming execution with a target AP MLD. For example, a data delivery timeout value, a data drain timeout, or DL data drain timeout defines a period for retrieving buffered DL data before fully transitioning to the target AP. The time period can be set based on multiple factors, such as current RSSI, MCS, and/or the amount of buffered DL data. This DL data draining capability enables the serving AP to deliver buffered DL data to the client to minimize or avoid data loss during the roaming transition. Second, a DL data forwarding mechanism allows the serving AP MLD to forward buffered DL data to the target AP MLD over a backhaul connection, with the target AP MLD then delivering this forwarded data to the client device. Data forwarding may be particularly useful when the client device's radio conditions with the serving AP are poor, as it avoids the need for the client to retrieve data over a weak link. These mechanisms are particularly important for client devices with a single radio that can only be actively connected to one AP at a time, as such devices must allocate their limited radio resources between retrieving buffered DL data from the serving AP and establishing data exchanges with the target AP.

However, existing seamless roaming mechanisms lack any means for the client device to indicate its preferences regarding how buffered DL data should be handled. Different scenarios may favor different approaches to buffered data handling, but the client device currently has no way to signal its preferred mode of operation. For example, when the client device has weak RSSI with the serving AP MLD, the client may prefer to immediately transition to the target AP and forgo retrieving buffered DL data directly from the serving AP. With a weak connection, reception of the buffered DL data may take substantially longer than necessary (with low modulation and coding scheme (MCS) being used) to fetch the buffered DL data, and the client may prefer that any buffered data be forwarded to the target AP instead. In other cases, when the client still has sufficient RSSI with the serving AP MLD, it may prefer to retrieve a portion or all of the buffered DL data before fully transitioning to the target AP MLD. Additionally, the client may have preferences regarding which types of data should be prioritized for draining or forwarding, such as preferring to drain or forward only certain Traffic Identifiers (TIDs), Access Categories (ACs), or Stream Classification Service (SCS) streams that are most critical to the client's applications. The client may also have preferences regarding whether data should be drained, forwarded, or handled using a combination of both approaches. Without a mechanism to signal these preferences, the network cannot adapt the buffered data handling to the client's specific needs and radio conditions, potentially resulting in suboptimal roaming performance, unnecessary delays, loss of data, or inefficient use of network resources.

Signaling and related behaviors of the client device and APs are described herein for a client device to signal its preferences for buffered DL data delivery from the serving AP MLD. The client device may indicate whether it prefers to drain buffered DL data, forward buffered DL data, or use a combination of draining and forwarding. The client device may further specify preferences at a granular level, such as indicating specific TIDs, ACs, or SCS streams for which particular handling modes are preferred. The serving AP MLD may acknowledge these preferences and indicate in a response which handling modes will be employed. These preference signaling mechanisms enable more efficient and adaptive buffered data handling during seamless roaming transitions, improving roaming performance and user experience across diverse radio conditions and application requirements.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or,” “and/or,” “at least one of,” and “one or both of” as used herein are to be interpreted as inclusive or meaning any one or any combination. Therefore, “A, B, or C” or “A, B, and/or C” mean “any of the following: A; B; C; A and B; A and C; B and C; A, B and C.” An exception to this definition will occur only when a combination of elements, functions, steps, or acts are in some way inherently mutually exclusive.

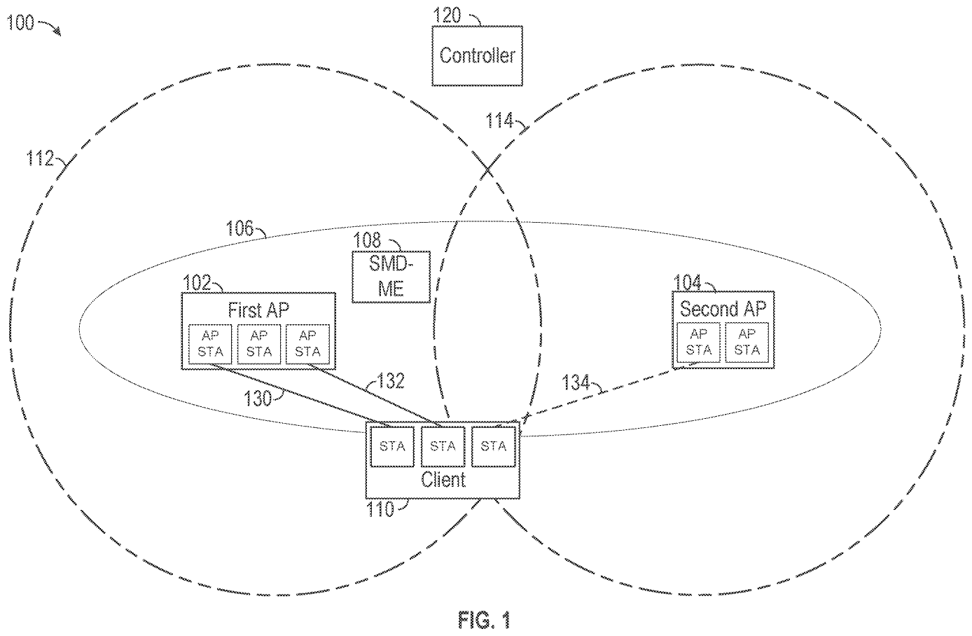

FIG. 1 is a block diagram of an operating environment 100 for client preferences signaling for buffered DL data delivery during seamless roaming. In the illustrated embodiment, the operating environment 100 includes a first AP 102, a second AP 104, a client device 110, and a controller 120. The first AP 102 has a service area or cell indicated by the first cell 112, and the second AP 104 has a service area indicated by the second cell 114. The range of the first AP 102 and the second AP 104 may extend past the boundaries of the associated cells, resulting in overlapping coverage, but the signals grow weaker as devices move away from the respective APs. Thus, the first AP 102 and the second AP 104 may fail to communicate reliably with devices some distance past the edges of the associated cells. The edges of the first cell 112 and the second cell 114 as shown in the operating environment 100 are examples and may be different in other implementations (e.g., different sizes, shapes, etc.).

The APs in the operating environment 100 are grouped into one or more SMDs, such as the SMD 106 in the illustrated embodiment. The SMD 106 provides seamless roaming to clients across AP MLDs within the SMD 106. A client device 110 associates at the SMD level with an SMD-Management Entity (ME) 108 within the SMD 106 and then roams between AP MLDs within the SMD 106 without performing reauthentication or reassociation, to achieve seamless roaming. The first AP 102 and second AP 104 are part of the same SMD 106 in the illustrated embodiment.

The client device 110 is any device that connects to the network to communicate with other devices on the network, such as a smartphone, a tablet, a personal computer, a laptop, an Internet of Things (IoT) device, and/or the like. As illustrated in FIG. 1, the client device 110 is currently associated with the SMD 106 (e.g., via the SMD-ME 108), within the first cell 112, and connected with the first AP 102. However, the client device 110 may be moving toward the boundary of the first cell 112 and into the second cell 114, indicating that the client device 110 may soon need to roam from the first AP 102 to the second AP 104 or another neighbor AP to maintain network connectivity and quality of service (QoS).

An AP, such as the first AP 102 and the second AP 104, is generally a fixed station that communicates with client devices and may also be referred to as a base station, wireless device, or some other terminology. The APs may support seamless roaming procedures (e.g., as defined in the IEEE 802.11bn amendment), including roaming preparation and roaming execution (or roaming transition) phases, that enable the client device 110 to transition between APs (e.g., AP MLDs) within the same SMD 106 with reduced roaming latency and data loss. In some embodiments, the first AP 102 and the second AP 104 are in a same SMD, enabling seamless roaming between them without the client device 110 needing to disconnect, re-authenticate, re-associate, or experience packet loss.

The controller 120 may be any network controller (e.g., a WLAN controller) and may manage the first AP 102, the second AP 104, the SMD 106, the SMD-ME 108, and/or other network devices (not shown) to allow wireless devices such as the client device 110 to connect to the network. In some embodiments, the operations of the controller 120 described herein may be performed by one or more of the first AP 102, the second AP 104, and/or another device, and vice versa. In some embodiments, for example, the controller 120 is included within or integrated with an AP and coordinates the links formed by that AP. In some embodiments, the controller 120 is separate from the APs and coordinates the links of multiple APs. The operating environment 100 is an example configuration and there may be a different number of clients, APs, controllers, and/or other devices in further examples.

As used herein, an AP along with the client devices associated with the AP (e.g., the client devices within the coverage area or cell of the AP) may be referred to as a BSS. In the illustrated example, the first AP 102 is the serving AP for the client device 110 within the first cell 112. The APs may communicate with one or more client devices on the DL and uplink (UL). The DL is the communication link from an AP to a client device 110, and the UL is the communication link from a client device 110 to an AP. In some cases, a client device 110 may also communicate peer-to-peer with another client device.

As shown in FIG. 1, the client device 110 and the APs are MLDs and each include one or more STAs. The client device 110 uses the STAs to form links with the AP STAs. For example, the client device 110 may use a first STA to form a first wireless link 130 with a corresponding STA of the first AP 102, and the client device 110 may use a second STA to form a second wireless link 132 with another STA of the first AP 102. Each STA may include Physical (PHY)-layer and lower-Media Access Control (MAC) components. The MLDs may also include an upper-MAC for coordinating the multiple STAs (or links) that are part of the MLD. The STAs can use different frequency bands for various wireless links. For example, the first wireless link may be formed using a 5 GHz band and the second wireless link may be formed using a 6 GHz band. Note, however, that these are merely example frequency bands and that the wireless links may use any suitable frequency bands, including 2.4 GHz, 5 GHz, 6 GHz, or other bands.

In general, the AP(s) and the client device 110 may form any suitable number of links for communication using any suitable frequencies. In some instances, the client device 110 may form links with one AP (e.g., the first link 130 and the second link 132 with the first AP 102). In other instances, the client device 110 may form links with multiple APs (e.g., the first link 130 and the second link 132 with the first AP 102 and a third link 134 with the second AP 104). As a result, the client device 110 may communicate with one or more APs over multiple links using different frequencies. Additionally, setup links may not always be active or otherwise useable. For example, the third link 134 may be setup with the second AP 104 as part of roaming preparation, but the roaming execution may not have occurred yet. After roaming execution to the second AP 104, the third link 134 can be used.

The controller 120 may provide coordination and control for the APs. For example, the controller 120 may handle adjustments to radio frequency power, channels, authentication, association, and security for the APs. The controller 120 may also coordinate the links formed by the client device(s) 110 with the APs. For example, the controller 120 may coordinate when the client device 110 and an AP communicate over a link using a particular frequency, the type of data communicated over a particular link, when the client device 110 and the AP form or terminate certain links, and/or when the client device 110 and AP (pre)-associate with each other to (pre)-establish certain links.

The client device 110 may be referred to as a STA MLD or non-AP MLD (e.g., a STA or client device acting as an MLD) and the first AP 102 or second AP 104 may be referred to as an AP MLD (e.g., an AP that acts as an MLD). The STA MLD and AP MLD are generally representative of any device capable of performing multi-link (ML) operations. An MLD may generally be classified based on whether it is a single radio MLD or multi-radio MLD. Single radio MLDs generally use a single radio (e.g., STA) to switch between one or more links. One category of single radio MLDs is Enhanced Multi-Link Single Radio (eMLSR). eMLSR devices generally operate one main wireless radio that can transmit and/or receive data frames on a given link, but can listen in low capability on a set of links when the device is not actively transmitting or receiving. Multi-radio MLDs may generally be classified into the following two types: (i) simultaneous transmission and reception (STR) MLD and (ii) non-STR MLD. For STR MLDs, a transmission on one link does not affect the operations of frame reception and clear channel assessment (CCA) on other links. Stated differently, for STR MLDs, individual links can operate independently of each other. For non-STR MLDs, the operation on one link may be restricted by the operation on another link. For example, a transmission on one link may not be allowed if it will cause reception interruption on another link, or a reception or CCA on one link may not be allowed if a transmission is ongoing on another link.

In certain embodiments, the operating environment 100 may enable the client device 110 to utilize seamless roaming techniques such as roaming without performing re-association with one or more APs, receiving neighbor reports to determine a target AP, and so on. In certain embodiments, as the client device 110 moves away from the coverage of an AP, the client device 110 may perform roaming preparation procedures to add links with a target AP MLD as it roams in the coverage of target APs within the SMD 106 to continue connectivity with the network. In certain embodiments, the beacons'signal strength (e.g., RSSIs) from APs in the client device 110 roaming path acts as triggers for initiating roaming preparation to add links with target AP MLD(s).

In some embodiments, the AP within the SMD 106 advertise their data forwarding capabilities and policies to enable client devices to make informed decisions about buffered DL data handling preferences. For example, an AP may advertise whether it supports data forwarding, and if so, may advertise a data forwarding policy indicating what types of data can be forwarded (e.g., all traffic, certain ACs/TIDs/SCS streams, MSDUs/A-MSDUs only, limits on data size or duration for data forwarding, etc.). This capability and policy information may be advertised in Beacon frames, Probe Response frames, (Re)Association response frames, or other management (or action) frames and may be included in the SMD information element or other elements. The client device 110 can use this advertised information when formulating its buffered DL data handling preferences in the ST preparation request or ST execution request.

During seamless roaming from the first AP 102 (serving AP or current AP) to the second AP 104 (target AP), buffered DL data at the serving AP can be handled in multiple ways to minimize data loss. The serving AP may drain buffered DL data by transmitting it directly to the client device 110 even after roaming execution with the target AP has commenced or completed. Alternatively or additionally, the serving AP may forward buffered DL data to the target AP over a backhaul connection, with the target AP then delivering this forwarded data to the client device 110. The choice between draining and forwarding, or a combination of both approaches, can significantly impact roaming performance and efficiency.

However, existing seamless roaming mechanisms lack any means for the client device 110 to indicate its preferences regarding how buffered DL data should be handled. Different scenarios may favor different approaches to buffered data handling based on radio conditions, application requirements, and network capabilities. For example, when the client device 110 has weak RSSI with the serving AP (e.g., the first AP 102), draining buffered DL data may take substantially longer than necessary due to a low MCS being used, and the client device 110 may prefer that any buffered DL data be forwarded to the target AP instead or that it immediately transition to the target AP without retrieving the buffered data. Conversely, when the client device 110 still has sufficient RSSI with the serving AP, it may prefer to retrieve a portion or all of the buffered DL data before fully transitioning to the target AP. Additionally, the client device 110 may have preferences regarding which types of data should be prioritized, such as preferring to drain or forward only certain TIDs, ACs, or SCS streams that are most critical to the applications of the client device 110, while being willing to accept data loss for less critical flows.

In certain embodiments, the client device 110 can signal its preferences for buffered DL data handling in a roaming execution request (e.g., ST execution request), used for performing the roaming execution or may be sent after the roaming execution exchange. In some embodiments, the client device 110 can even signal its preferences for buffered DL data handling in a roaming preparation request (e.g., ST preparation request) used for performing roaming preparation, before the roaming execution. For example, the client device 110 may signal whether it prefers to drain buffered DL data, forward buffered DL data to the target AP, or use a combination of draining and forwarding. The client device 110 can provide granular preferences by specifying particular TIDs, ACs, or SCS streams for which specific handling modes are preferred. In a roaming execution response, the serving AP can respond by acknowledging these preferences and indicating the parameters it will use for delivering buffered DL data, such as the set of ACs/TIDs/SCS IDs for which it will deliver or forward buffered DL data and the set of links where it will deliver that data. In example implementations, the default behavior (e.g., in the absence of signaling indicating preferences of the client device 110) is that the client device 110 is interested in receiving all buffered DL data that is not forwarded to the target AP.

A roaming execution request is used to indicate the request to perform roaming execution to a target AP. As described in further detail herein, after the roaming execution exchange is completed, a roaming transition phase may commence. A DL data delivery phase can occur during the roaming transition phase, in which the serving AP can transmit buffered DL data to the client device 110 or forward buffered DL data to the target AP based on the negotiated preferences network capabilities, and network conditions. During the roaming transition, the client device 110 may be waiting for the serving AP to finish transmitting buffered DL data before it fully transitions to the target AP, or the client device 110 can determine to fully transition to the target AP before receiving all buffered DL data.

The serving AP may keep buffered DL data available for delivery to the client device 110 or available to be fetched by the client device 110 for a predetermined period. The period can be indicated in a roaming response (e.g., a roaming preparation response, a roaming execution response) in example implementations. In other implementations, a default time period can be advertised by an AP (e.g., in a Buffered DL data Delivery period field in an SMD element or SMD information element) that will apply for all roaming transitions.

In some embodiments, the client device 110 determines to fully transition (e.g., transition all its radio resources) to the target AP before the expiration of the period for buffered DL data delivery. For example, the client device 110 may determine the connection with the serving AP is weak or prefer the buffered DL data be forwarded to the target AP and fully transition to the target AP. The client device 110 is configured to inform the serving AP that the client device 110 will not be receiving buffered DL data any more from the serving AP. This signaling enables the serving AP to avoid unnecessary attempts to deliver any remaining buffered DL data to the client device 110 which may lead to inefficient use of the channel resource. Instead, the serving AP can allocate channel access time to other client devices, providing more efficient use of the channel.

For seamless roaming, after the roaming execution exchange is completed, the client device 110 can switch its radio resources between the current serving AP and the target AP. This behavior can typically be based on the radio capability of the client device 110. For example, a single radio client device 110 can switch its radio resources back and forth between serving AP and target AP. A multi-radio capable client device 110 may keep one or more radios connected to the serving AP to fetch buffered DL data and can switch other radio resources to the target AP to perform UL and DL exchange with target AP. In some implementations, the client device 110 may implement sequential data retrieval, where it first receives all the data it wants to or can receive from the serving AP based on its radio conditions, and then transitions its radio resources to the target AP to perform DL and UL data exchange with the target AP.

When the client device 110 is switching its radio resources from the serving AP to the target AP, the client device 110 needs to signal to the serving AP that those links are no longer available for buffered DL data delivery. Thus, the client device 110 is configured to send a frame signaling links are in power save mode (e.g., Power Management (PM)=1) for the one or more links that will no longer be available with the serving AP. For example, the client device 110 sends a QoS Null frame indicating one or more links are in power save mode to the serving AP. The client device 110 can use cross-link PM indication (e.g., as defined in IEEE 802.11bn) to signal one or more links that will not be available for buffered DL data delivery. When the client device 110 switches back some of its radio resources from target AP back to the serving AP, the client device 110 signals which links are out of power save mode (e.g., PM=0) to signal availability of one or more links for receiving buffered DL data

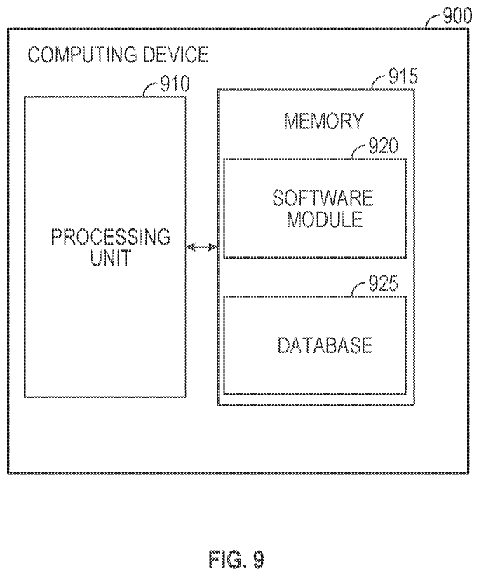

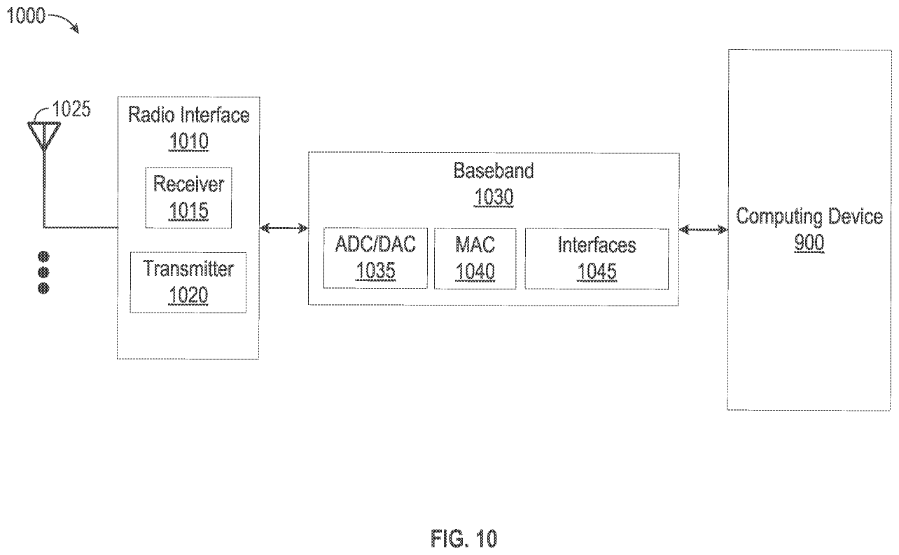

The elements described above of the operating environment 100 (e.g., the first AP 102, the second AP 104, the SMD-ME 108, the client device 110, the controller 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 9 and 10, the elements of the operating environment 100 may be practiced in a computing device 900 and/or communications device 1000.

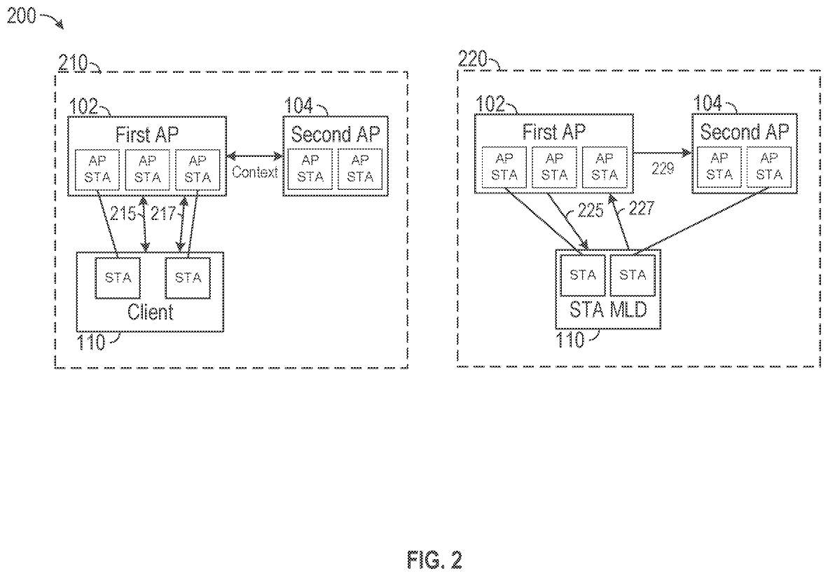

FIG. 2 illustrates an example seamless roaming process 200 with the client device 110 roaming from the first AP 102 (serving AP) to the second AP 104 (target AP) (e.g., within the SMD 106). The seamless roaming process 200 includes a roaming preparation procedure and roaming execution procedure. The roaming preparation procedure involves coordination between a serving AP and one or more target APs, to add one or more links at the target APs and reserve resources at the target APs (such as SCS and Block Acknowledge resources). After roaming preparation is complete, the client device 110 then performs roaming execution to complete its roaming transition to the target AP. The two phases of the roaming procedure minimize connection disruption during roaming and provide faster and more seamless roaming.

Roaming preparation and execution is shown in phase 210. During the phase 210, the client device 110 and the first AP 102 perform an ST preparation exchange 215. The ST preparation exchange 215 includes an ST preparation request sent from the client device 110 to the first AP 102, indicating that the client device 110 intends to roam to one or more target APs and requests to prepare or add links on those target APs. In response to the ST preparation request, the first AP 102 sends context related to the client device 110 to the second AP 104 and potentially other target APs indicated in the request or identified by the first AP 102. The context transferred may include link setup information, parameters related to block acknowledgement agreements setup for the client device 110, SCS streams setup for the client device 110, mirrored SCS (MSCS) streams setup for the client device 110, target wake time (TWT) agreements setup for the client device 110, TID-to-link mapping (TTLM) agreements setup for the client device 110, security association context associated with the client device 110, capabilities of the client device 110, and/or other context information. The target AP can provide a response to the first AP 102 to indicate the outcome of roaming preparation at the target AP (e.g., to indicate whether roaming preparation was successful and indicate the set of links (and parameters) that are added at the target AP MLD).

The ST preparation exchange 215 further includes an ST preparation response sent from the first AP 102 to the client device 110 indicating whether the roaming preparation request succeeds, for example indicating whether one or more target APs accepted the roaming preparation request and indicate the set of links that were added on the target AP. If at least one target AP (the second AP 104 in the illustrated embodiment) accepts the roaming request and has setup one or more links for the client device 110, the preparation procedure in phase 210 is considered successful. The ST preparation exchange 215 can further include additional ST requests, context transfers, and ST responses if the roaming request fails or to provide multiple target AP options to the client device 110. The roaming preparation procedure can include any operations described in various IEEE 802.11 specifications and amendments, including the IEEE 802.11bn amendment.

Following successful completion of the ST preparation exchange 215, the first AP 102 and the client device 110 can perform a roaming execution procedure to enable the client device 110 to transition to the second AP 104. Roaming execution involves the client device 110 performing an ST execution exchange 217 with the first AP 102. The ST execution exchange 217 completes the roaming execution to the second AP 104. In some embodiments, the roaming execution exchange can also be performed directly with the target AP (not shown in FIG. 2).

In the ST preparation exchange 215 and/or the ST execution exchange 217, the client device 110 can signal its preferences for buffered DL data handling. The client preferences for buffered DL data handling can be signaled in the ST preparation request or ST execution request. For example, the client device 110 may signal whether it prefers to drain buffered DL data (retrieve data directly from the serving AP), forward buffered DL data to the target AP, or use a combination of draining and forwarding. The client device 110 may also specify granular preferences, such as indicating particular TIDs, ACs, or SCS streams for which it prefers draining or forwarding. The serving AP can respond by acknowledging these preferences and indicating in the ST preparation response or the ST execution response the parameters it will use for handling buffered DL data, such as which TIDs will be drained or forwarded and the duration for which buffered data will be available for delivery. These preference signaling mechanisms enable the network to adapt buffered data handling to the client device 110's specific radio conditions and application requirements, which may vary significantly depending on factors such as RSSI with the serving AP, client radio capabilities, backhaul conditions, and flow criticality.

After roaming execution is completed (following the ST execution exchange 217), the client device 110 enters a roaming transition phase 220, comprising a buffered DL data delivery phase. In the roaming transition phase 220, the client device 110 has established at least one link with the second AP 104 (the target AP) and may maintain at least one link with the first AP 102, for example to perform retrieval of buffered DL data from the first AP 102. During this phase, buffered DL data at the first AP 102 can be handled in one or more of several ways based on the preferences negotiated during the ST exchanges, network capabilities, and network conditions (e.g., backhaul conditions). The first AP 102 may drain buffered DL data by transmitting it directly to the client device 110 (data exchange 225), forward buffered DL data to the second AP 104 over a backhaul connection for subsequent delivery to the client device 110 (data transmissions 229), or use a combination of both draining and forwarding. The duration of the roaming transition phase 220 may be defined by a data delivery timeout or DL data drain timeout indicated in the ST execution response or advertised in an SMD element.

The behavior of the client device 110 during the roaming transition phase 220 depends on its radio capabilities and the negotiated buffered data handling approach. In one embodiment, during the roaming transition phase 220, the client device 110 may be connected to only one AP at a time (e.g., a single radio client device). A single radio client device 110 may perform sequential operation with the first AP 102 and the second AP 104, where the client device 110 first performs retrieval of any buffered DL data from the first AP 102 based on its radio conditions and preferences, and then fully transitions all its links to the second AP 104 (the target AP for the roam). In some embodiments, during the roaming transition phase 220, the client device 110 may be going back and forth between the links of the first AP 102 and the second AP 104. In yet another embodiment, during the roaming transition phase 220 the client device 110 may be connected to both the first AP 102 and the second AP 104 simultaneously (e.g., if the client device is a multi-radio device). A multi-radio client device 110 may keep one or more radios connected to the first AP 102 to fetch buffered DL data while simultaneously using other radio resources with the second AP 104 to perform UL and DL exchange with the second AP 104.

In the roaming transition phase 220, the client device 110 can inform the serving AP that the client device 110 will not be receiving buffered DL data any more from the serving AP, enabling early termination of the DL data delivery phase (client signaling 227). This signaling 227 enables the serving AP to avoid unnecessary attempts to deliver any remaining buffered DL data to the client device 110 which may lead to inefficient use of the channel resource. Instead, the serving AP can allocate channel access time to other client devices, providing more efficient use of channel. Additionally, the client device 110 can provide signaling 227 to indicate to the serving AP which links are available (out of power save mode) and unavailable (in power save mode) for receiving buffered DL data. The client device 110 can update the link availability as it transitions links back and forth between serving AP and the target AP. For example, the client device 110 can send a frame with PM=1 indication to signal that one or more links are entering power save mode and are unavailable for buffered DL data delivery, and can send a frame with PM=0 indication to signal that one or more links are out of power save mode and available for receiving buffered DL data. The client device 110 can use cross-link PM indication to signal availability or unavailability of multiple links for buffered DL data delivery. The frames used to signal link availability or unavailability for receiving buffered DL data from the client device 110 to the first AP may be a QoS Null frame or a management frame (or an action frame, such a UHR Link Reconfiguration Notify frame).

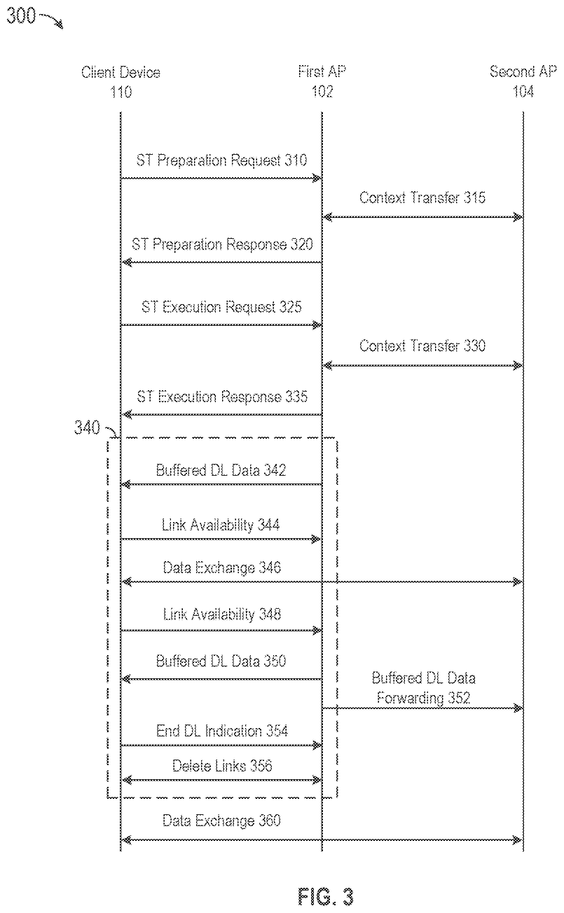

FIG. 3 is a message exchange diagram illustrating a procedure 300 for client signaling preferences for buffered DL data handling during seamless roaming. The illustrated procedure 300 shows communications between the client device 110, the first AP 102 (serving AP), and the second AP 104 (target AP) during a seamless roaming process that incorporates the buffered DL data preference signaling mechanisms described herein.

At some point prior to the message exchanges illustrated in FIG. 3, the client device 110 may determine to initiate a seamless roaming process. Initiating a seamless roaming process by the client device 110 may be triggered upon receiving a report from the first AP 102. Such report may be generated based on observed network conditions and parameters associated with the quality of connection of the client device 110 with the first AP 102 and/or other APs that are available. Alternatively, the client device 110 may determine to initiate seamless roaming based on RSSI measurements, trajectory predictions, BSS load, or other factors. Upon making this determination, the client device 110 may optionally perform initial signaling exchange with the first AP 102, such as requesting a Neighbor Report from the first AP 102 that includes identification of several available target APs.

Once the client device 110 determines to initiate seamless roaming, the client device 110 sends an ST preparation request to the first AP 102 in stage 310. The ST preparation request may be implemented as an ultra high reliability (UHR) Link Reconfiguration Request frame or another signaling frame. For example, the UHR Link Reconfiguration Request may include one or more Reconfiguration ML elements indicating links to be added or setup with one or more candidate target APs along with (optionally) a preference order of desired candidates. The ST preparation request may further include other roaming related indication and parameters such as a preparation indication, a Roaming SN, a context transfer indication indicating the set of contexts to be transferred, a resource reservation request, a context negotiation request, and/or other roaming context information.

In certain embodiments, the ST preparation request includes client preferences for how to handle buffered DL data. The client device 110 may signal whether it prefers to drain buffered DL data, forward buffered DL data to the target AP, or use a combination of draining and forwarding. The client device 110 may provide granular preferences by specifying particular TIDs, ACs, or SCS streams for which specific handling modes are preferred.

After receiving the ST preparation request in stage 310, the first AP 102 may determine a final list of candidate target APs. This list may include the second AP 104 and potentially other target APs. Once the list is determined, the first AP 102 performs context transfer in exchange 315 with the candidate target APs (including the second AP 104) to transfer one or more roaming context parameters and reserve resources on the candidate target APs, and/or to perform negotiation of one or more roaming context parameters with the candidate target APs and to setup link(s) with the candidate target APs.

The roaming preparation and context transfer may include transfer of near static context (or any selected context information which could include estimated future values for dynamic context such as SN and/or PN that can be used by the target AP) to one or more candidate target APs for roaming in the future, pre-setting up of links on one or more candidate target APs (with the links not yet activated and 802.1x port not yet open for data transfer), and optional resource reservation for one or more resources on the candidate target APs for a time period (such as a Roaming Execution Timer duration). The resources reserved may include pre-assignment of setup links for the client device 110, reserving QoS resources for one or more SCS streams as requested by the client device 110 or selected by the first AP 102, reserving resources for TWT agreements (either existing TWT agreements that are requested to be transferred to specific links or new TWT agreements that are requested to be negotiated), reserving Block Acknowledgment resources, and/or reserving any other resources requested by the client device 110 or selected by the first AP 102. The context transferred may include parameters related to block acknowledgement agreements setup for the client device 110, SCS streams setup for the client device 110, MSCS streams setup for the client device 110, TWT agreements setup for the client device 110, TTLM agreements setup for the client device 110, security association context associated with the client device 110, capabilities of the client device 110, and/or other context information. The static context to be transferred to candidate target APs may be specified by the client device 110 and the first AP 102 (negotiated between them).

Following the context transfer in exchange 315, the first AP 102 sends an ST preparation response to the client device 110 in stage 320. The ST preparation response may include an indication of one or more candidate target APs (such as a list of candidate target APs that may be listed in preference order) that are prepared for roaming, an indication of a set of one or more static context parameters that were transferred to the candidate target APs, an indication of one or more context parameters that were negotiated with the candidate target APs, an indication of resources reserved at the candidate target APs (e.g., links that are added with the target APs), an Association Identifier (AID) assigned to the client device 110, and/or a Roaming Allowance Duration (RAD) or Roaming Execution Timer value (indicates the time within which roaming execution should be initiated).

In embodiments where a UHR Link Reconfiguration Request is used for roaming preparation, a corresponding UHR Link Reconfiguration Response may include ML element(s) (e.g., Basic Multi-link element or Reconfiguration ML element) for one or more target APs that are prepared and roaming context information that includes one or more of status (e.g., accept/reject) for roaming preparation, a roaming preparation indication, a Roaming SN, context transfer indication that indicates the set of context that were transferred, context negotiation indication that indicates one or more context parameters that were negotiated with the candidate target APs, resource reservation indication indicating the set of resources reserved, RAD/Roaming Execution Timer, and/or other information. The Roaming SN may be used to tie the roaming preparation phase with a subsequent roaming execution phase. If at least one candidate target AP (the second AP 104 in the illustrated embodiment) accepts the ST preparation request, the preparation phase is considered successful. Once the ST preparation response is received by the client device 110, the roaming preparation phase may be considered complete.

Thereafter, the client device 110 may determine a target AP to roam to from among the list of candidate target APs that are prepared for SMD roaming using exchanges described in stage 310 and stage 320. For example, the client device 110 may select the second AP 104 as the target AP to roam to. This determination may be based on RSSI measurements, location and trajectory information, channel load observations, preference order provided in the ST preparation response, and/or other factors. Once the client device 110 determines the target AP, the roaming execution phase may be triggered when the client device 110 sends an ST execution request to the first AP 102 in stage 325.

Using the ST execution request, the client device 110 may send a roaming execution request (e.g., an Add Link Request, a UHR Link Reconfiguration Request, etc.) to the first AP 102 to request roaming execution to the selected target AP (the second AP 104). The ST execution request may include roaming context information that includes one or more of a field for execution indication, a Roaming SN to tie the roaming execution phase with the roaming preparation phase, a context transfer indication indicating set of (dynamic) context to be transferred, context negotiation indication that indicates one or more context parameters to negotiate with the target AP, and/or other information.

In certain embodiments, the ST execution request includes client preferences for how to handle buffered DL data. The ST execution request is the most natural place for the client device 110 to signal its buffered DL data preferences, as the client device 110 has the most up-to-date knowledge of its active flows, radio conditions with the serving AP, and application requirements at this point in time. The client device 110 may signal whether it prefers to drain buffered DL data (retrieve data directly from the serving AP), forward buffered DL data to the target AP, use a combination of draining and forwarding (e.g., drain first then forward remaining data, or drain and forward in parallel), or forgo draining entirely if forwarding is supported. The client device 110 may also specify granular preferences at the TID, AC, or SCS stream level, indicating which flows should be drained, forwarded, or prioritized. Additionally, the client device 110 may indicate specific link IDs on which it prefers to receive buffered DL data, or may indicate that buffered DL data can be delivered on any link that is not in power save mode (PM=0). The default behavior absent signaling indicating preferences is that the client device 110 is interested in receiving all buffered DL data that is not forwarded to the target AP on any links that are not in power save mode.

After the first AP 102 receives the ST execution request in stage 325, optional context transfer in exchange 330 may take place between the first AP 102 and the target AP (the second AP 104). This exchange may be performed according to any known or to be developed signaling procedure whereby the first AP 102 confirms the roaming with the selected target AP and exchanges dynamic context (e.g., SN and/or Packet Number (PN)) with the selected target AP. During the dynamic context transfer, in parallel, the target AP (the second AP 104) may initiate a Distribution System (DS) mapping change to switch the data path for the client device 110 from the first AP 102 to the second AP 104. The DS mapping change may be completed via signaling exchange between the second AP 104 and the DS, enabling the network to route data traffic for the client device 110 to the second AP 104 rather than the first AP 102.

The first AP 102 sends an ST execution response in stage 335 to the client device 110 to confirm that roaming execution and dynamic context transfer as part of that process is complete. The ST execution response may be implemented as an Add Link Response, a UHR Link Reconfiguration Response, or other signaling frame. The ST execution response may include roaming context information such as information indicating status of the roaming execution (e.g., accept/reject), an execution phase indication, a Roaming SN, a context transfer indication indicating set of context that were transferred to the target AP, Group Keys of the links setup with the target AP, and/or other information.

In certain embodiments, the first AP 102 indicates in the ST execution response the parameters it will use for delivering buffered DL data, for example based on the client preferences for handling buffered DL data signaled in the ST execution request (or ST preparation request). For example, the first AP 102 can signal the set of ACs/TIDs/SCS IDs for which it will deliver buffered DL data to the client device 110 or forward buffered DL data to a target AP, the set of links where it will deliver that data, a data delivery timeout or DL data drain timeout defining the period for buffered data delivery, and/or an indication that the first AP 102 wants the client device 110 to indicate when the client device 110 is no longer interested in receiving buffered DL data from the serving AP. The serving AP can accept, reject, or modify the client's preferences based on network policy, backhaul conditions, and other implementation factors. The serving AP response enables the client device 110 to understand how buffered data will be handled and plan its roaming transition accordingly.

Following the ST execution response in stage 335, the first AP 102 may optionally cancel resources reserved on other candidate target APs (which occurred along with static context transfer during the context transfer in exchange 315). Alternatively, the resource reservation (and links setup) on other candidate target APs can expire automatically (e.g., upon expiration of a timer which may be the same or different than the RAD).

Before and/or after transmitting the ST execution response in stage 335, the first AP 102 and the client device 110 enter a buffered DL data delivery phase 340, also referred to as a roaming transition phase or DL data draining period. The buffered DL data delivery phase 340 represents the period during which the client device 110 may retrieve buffered DL data from the first AP 102 even after roaming execution with the second AP 104 has completed. During this phase, buffered DL data can be handled according to the negotiated preferences using one or more approaches: draining (the serving AP transmits buffered data directly to the client device 110), forwarding (the serving AP forwards buffered data to the target AP over a backhaul connection for subsequent delivery), or a combination of both.

For example, the first AP 102 may transmit buffered DL data to the client device 110 in stage 342 if the client device 110 indicated that it wanted to receive the buffered DL data (and while the buffered DL data delivery period has not expired). During stage 342, the client device 110 and the first AP 102 operate in DL data draining mode. The first AP 102 can deliver buffered DL data on any link where the client device 110 has indicated PM=0 (out of power save mode). If the client device 110 is a multi-radio device, it can signal PM=0 on multiple links to receive buffered DL data faster across multiple links.

In some embodiments, the client device 110 needs to modify which link(s) are available to receive buffered DL data from the first AP 102 as it switches its radio resources between the serving AP and the target AP. In stage 344, the client device 110 signals which links are available (e.g., out of power save mode with PM=0) and/or which links are not available (e.g., in power save mode with PM=1). For example, the client device 110 can send a QoS Null frame with PM=1 indication to signal that one or more links are entering power save mode and are unavailable for buffered DL data delivery. The client device 110 can use cross-link PM indication to signal availability or unavailability of multiple links for buffered DL data delivery. The client device 110 can use a management frame (or action frame) to signal availability or unavailability of links for buffered DL data delivery (e.g. by using a UHR Link Reconfiguration Notify frame).

In stage 346, the client device 110 can exchange data with the second AP 104 (target AP) using some of its radio resources to connect links with the second AP (e.g., using the links the client device 110 indicated as unavailable to the first AP 102 in the initial client preferences signaling, such as in the ST execution request, or indicated as unavailable to the first AP 102 in stage 344). In some implementations, one or more links are still available to the first AP 102, so the client device 110 may be communicating with the first AP 102 and the second AP 104 at the same time, for example if the client device 110 is a multi-radio device. In other implementations, such as when the client device 110 is a single radio device, the first AP 102 may have no available links (no active links out of power save mode with the client device 110) and must wait to resume sending the buffered DL data to the client device 110 until the client device 110 again signals which links are available and unavailable in stage 348. When the client device 110 switches back some of its radio resources from the second AP 104 back to the first AP 102, the client device 110 sends a frame with PM=0 indication to signal availability of one or more links for receiving buffered DL data. The first AP 102 can then resume sending buffered DL data to the client device 110 in stage 350.

In certain embodiments, the first AP 102 forwards some or all of the buffered DL data to the second AP 104 in stage 352 based on the negotiated preferences and network capabilities. The serving AP may forward data over a backhaul connection to the target AP, which then delivers the forwarded data to the client device 110. The decision on what data to drain versus forward can be made by the serving AP based on multiple factors including the types of active flows (e.g., VO, VI, BE), amount of buffered data, RSSI/MCS of the client device 110, backhaul link conditions, client preferences, and AP policy.

In some embodiments, the client device 110 determines to fully transition to the second AP 104 before receiving all of the buffered DL data and before the buffered DL data delivery period expires. For example, the client device 110 may determine the connection with the serving AP is weak or may prefer the buffered DL data be forwarded to the target AP. The client device 110 indicates the decision to fully transition to the first AP 102 in stage 354 so the first AP 102 knows to stop attempting to send the buffered DL data. This signaling is important so that the serving AP will not keep attempting to deliver any remaining buffered DL data to the client device 110, which may lead to inefficient use of the channel resource. Instead, the serving AP can allocate channel access time to other client devices, providing more efficient use of channel. The client device 110 can signal that it is done with receiving buffered DL data using various mechanisms, as described in further detail herein. Such a signaling 354 from the client device 110 could be a management frame or an action frame such as a UHR Link Reconfiguration Notify frame indicating client's intent to end buffered DL data drain with the first AP.

At the conclusion of the buffered DL data delivery phase 340 (e.g., there is no more buffered DL data, the buffered DL data delivery period expired, the client device 110 determined to fully transition to the second AP 104, etc.), the client device 110 completes the roaming transition and deletes all links with the first AP 102 in stage 356. In some embodiments, the deletion of links with the current AP may be done locally on the client device 110 without performing over-the-air exchange, when the client device 110 decides to end DL data drain with the current AP (e.g. by signaling ‘End DL indication’ 354). The client device 110 can then exchange data with the second AP 104 in stage 360, beginning or continuing UL and DL transmissions with the second AP 104.

While stages and exchanges 342, 344, 346, 348, 350, 352, 354, 356 are illustrated in FIG. 3, the buffered DL data delivery phase 340 can include other stages and exchanges in any order in further embodiments. For example, the buffered DL data delivery phase 340 may only include the buffered DL data being transmitted to the client device 110 and the links with the first AP 102 being deleted in example implementations. In another example, the buffered DL data delivery phase 340 can include the first AP 102 forwarding all of the buffered DL data to the second AP 104 and then deleting links with the client device 110. In yet another example, a client device 110 implementing sequential data retrieval may first receive all the data it wants to or can receive (based on its radio conditions) from the first AP 102, and then indicates an end of DL drain with the current AP and transitions its radio resources to the second AP 104 to perform DL and UL data exchange with the second AP 104.

### Client Preferences for Buffered DL Data Delivery

The client device 110 can signal its preferences for buffered DL data handling in the ST preparation request and/or the ST execution request to enable the serving AP to adapt buffered data handling to the client's specific needs. The signaling enables the client device 110 to express preferences based on its current radio conditions with the serving AP, its application requirements, its radio capabilities, and other factors that may affect the optimal approach to buffered data handling.

When the client device 110 is signaling its preferences, the signaling can take various forms depending on the level of granularity desired. In one embodiment, the signaling can indicate that the client device 110 is interested in receiving all buffered DL data, for example indicated by a simple ‘Deliver Buffered DL Data’ flag in the roaming execution request. In other implementations, the signaling can indicate that the client device 110 is interested in receiving buffered DL data only for certain specified ACs/TIDs/SCS streams, for example via an AC/TID bitmap and/or an SCS IDs list or bitmap. This granular signaling enables the client device 110 to prioritize reception of buffered data for flows that are most critical to its applications, such as low-latency and high-QoS flows.

In yet other implementations, the signaling can indicate that the client device 110 is interested in receiving only those buffered DL data that cannot be forwarded to the target AP if data forwarding can be done. This preference may be useful when the client device 110 has poor RSSI with the serving AP but the serving AP supports data forwarding to the target AP. In some implementations, the signaling can indicate that the client device 110 is interested in receiving buffered DL data only for certain ACs/TIDs/SCS streams that cannot be forwarded to the target AP (if data forwarding can be done).

In some implementations, the signaling can indicate that the client device 110 is interested in receiving only buffered DL MPDUs that have already been unsuccessfully transmitted. The client device 110 can request that the serving AP forward all other data (e.g., MSDUs/A-MSDUs and MPDUs) that have not yet been transmitted to the client device 110. This approach allows the client device 110 to complete reception of partially-transmitted data while enabling faster delivery of remaining data through forwarding.

In some implementations, the signaling can indicate that the client device 110 is not interested in receiving buffered DL data. In this case, client device 110 can request that serving AP forward to the target AP all or most buffered DL data or buffered DL data for specific TIDs/ACs/SCS streams. This preference may be desirable when the client device 110 has very weak RSSI with the serving AP and wishes to transition to the target AP immediately without attempting to drain any buffered data. The client device 110 may signal this preference using a “DL Data Drain Not Needed” indication in the ST execution request. When this preference is indicated and accepted by the serving AP, no DL data draining period duration is included in the ST execution response, or it is set to zero, and the serving AP does not attempt to drain any DL data to the client device 110 after sending the ST execution response.

At a high level, the client device 110 can signal whether it prefers to: (a) only drain buffered data, (b) only forward buffered data, (c) first drain as much as possible then forward remaining data, or (d) drain some data and forward some data in parallel. If option (c) or (d) is requested, the serving AP can determine what data to drain and what data to forward based on client conditions (RSSI/MCS), backhaul link conditions, and other factors. The client device 110 can set a “Drain First then Forward Buffered Data” flag to signal preference (c), and may indicate a list of TIDs/ACs/SCS IDs for which to first drain then forward.

Data forwarding is an optional capability that may be supported by APs within the SMD 106. APs can advertise whether they support data forwarding and, if supported, can advertise their data forwarding policy. The data forwarding policy may specify, for example, whether the AP supports forwarding of all traffic or only certain ACs/TIDs/SCS streams, whether forwarding is limited to MSDUs/A-MSDUs only (not yet transmitted at the MAC protocol data unit (MPDU) level), whether MPDUs can be forwarded, whether there are limits on data size or duration for data forwarding, and/or other policy parameters. This capability and policy information enables client devices 110 to understand what forwarding options are available and to formulate appropriate preferences aligned with the advertised policy.

The client device 110 can indicate granular preferences for data forwarding that are aligned with the policy advertised by the APs. For example, the client device 110 can indicate a set of ACs/TIDs/SCS IDs to forward, can request that only MSDUs/A-MSDUs be forwarded (excluding already-transmitted MPDUs), and/or can provide other forwarding preferences consistent with the advertised policy. In the roaming execution response, the serving AP can either accept the granular request from the client device 110 or provide confirmation on the set of data that will be forwarded (if any).

In some embodiments, the AP can have a policy to autonomously forward some high-QoS TID data to the target AP without any client request. For example, the serving AP may determine based on network policy and current conditions that certain high-priority flows (e.g., voice or video traffic) should be forwarded to the target AP to ensure minimal latency and avoid the need for the client to drain this data over a potentially weak link. In this case, the AP can signal what data will be forwarded in the roaming execution response to the client device 110.

The client device 110 can also indicate preferences regarding forwarding of transmitted data versus data that has not been transmitted. In some implementations, the client device 110 can request that only MSDUs/A-MSDUs that have not yet been transmitted be forwarded to the target AP, while the client device 110 drains any MPDUs that have already been transmitted. Alternatively, the client device 110 can request forwarding of transmitted MPDUs in addition to or instead of data that has not been transmitted. The serving AP response can indicate which types of data will be forwarded based on the client request, AP policy, and backhaul conditions.

In some embodiments, the client device 110 may also be interested in receiving buffered DL data on specific link or links. The signaling can further indicate on which link or links the client device 110 wants to receive buffered DL data from the serving AP. For example, the client device 110 may have stronger RSSI for particular links (e.g., 2.4 GHz and 5 GHz links, which have longer range than 6 GHz links) and indicates that the client device 110 would like to receive buffered DL data on those particular links. To indicate the links, the client device 110 can indicate link IDs for the links the client device 110 selects for receiving buffered DL data (e.g., in the ST execution request).

In certain embodiments, the client device 110 can explicitly signal to deliver buffered DL data on multiple links for faster delivery of buffered DL data. For example, a multi-radio client device 110 can indicate to deliver buffered DL data on multiple links. The client device 110 can signal the set of link(s) on which it wants buffered DL data to be delivered by: (a) explicitly signaling a set of link ID(s) to use for delivery of buffered DL data, or (b) indicating that the buffered DL data can be delivered on any link that is not in power save mode (has PM=0). The serving AP can then use one or more of links not in power save mode for buffered DL data delivery. In some implementations, the delivery of buffered DL data using multiple links is the default mechanism for the network devices and no specific signaling is necessary to enable the mechanism. The client device 110 may also use EMLSR mode to receive buffered DL data on the best available link across the set of EMLSR links.

The APs can also request that the client device 110 make multiple links available for buffered DL data drain to accelerate delivery of the data. For example, in the roaming execution response, the serving AP can request that the client device 110 enable (set PM=0 for) one or more specific links to enable faster delivery of buffered DL data across multiple links. Additionally, during the DL data draining phase, the serving AP can request the client device 110 to come out of power save mode on other links, for example via an A-Control field in a DL MPDU (or by sending a management frame for this such as a UHR Link Reconfiguration Notify frame), to enable faster drain. If the client device 110 is a multi-radio STR client that can be active (i.e. in PM=0) on multiple links, the AP may attempt to deliver buffered DL data over multiple links to minimize the data delivery time.

In some embodiments, the client device 110 also signals whether all indicated links should be used for buffered DL data delivery, or a subset of links can be used for delivery of buffered DL data. Based on this signaling, the serving AP can use all indicated links or a subset of links for delivery of buffered DL data.

The serving AP can split the TIDs for which it delivers buffered DL data across different links that are not in power save mode. For example, the serving AP can deliver a subset of TIDs (e.g., TIDs 0-3) on one link and deliver other TIDs (e.g., TIDs 4-7) on another link.

In some embodiments, the TID-to-link mapping (TTLM) can be automatically reset to default (all TIDs mapped to all links) at the serving AP after the roaming execution exchange, to provide flexibility of delivering any TID traffic over any link. In other embodiments, the TTLM is not reset to default at the serving AP after roaming execution, and the serving AP follows the established TTLM to determine which TID traffic is delivered on which active link (with PM=0). In further embodiments, the client device 110 can request reset of TTLM to default TTLM or can request to establish a different TTLM with the serving AP as part of the roaming execution request (e.g., by including a TTLM element in the request). The revised TTLM is then used by the serving AP to determine which links to send the buffered DL data to the client device 110.

In one embodiment, the default behavior can be that the buffered DL traffic is delivered on the link where the roaming execution request/response exchange happens plus optionally on any other link with PM=0 while following the existing TTLM (or default TTLM), if no other preference is indicated by the client device 110.

In one embodiment, the client device 110 may also operate in the eMLSR mode of operation with the serving AP when receiving buffered DL data delivery from the serving AP, where it has indicated a set of one or more eMLSR links where it can receive buffered DL data. The eMLSR mode of operation can be enabled before or after the roaming execution request/response exchange.

In certain embodiments, the serving AP signals, in the roaming execution response frame, the parameters it will use for delivering buffered DL data. For example, the serving AP can signal the set of ACs/TIDs/SCS IDs for which it will deliver buffered DL data to the client device 110. It can also signal the set of links where it will deliver that data. It can also signal that it wants the client device 110 to indicate when the client device 110 is no longer interested in receiving the buffered DL data from the serving AP. The client device 110 can provide this indication on a per TID level or overall for all TIDs. The serving AP response enables negotiation and acknowledgment of the buffered data handling approach, ensuring that both the client device 110 and serving AP have aligned expectations for the roaming transition phase.

### Client Signaling When Done With Receiving Buffered DL Data

The serving AP will typically keep the buffered DL data available for delivery to/fetch by the client device 110 for a time period, which can be indicated in the roaming response (e.g., ST preparation response or ST execution response). A default time period can be advertised by the AP (e.g., in a Buffered DL data Delivery period field in an SMD element) that will apply for all roaming transitions.

In many cases, the client device 110 may decide to transition all its radio resources to the target AP before the timer for buffered DL data delivery expires. For example, the client device 110 may determine that its RSSI with the serving AP has degraded significantly, making continued data reception inefficient or impractical. In such cases, the client device 110 should inform the serving AP that it will not be receiving buffered DL data any more from the serving AP. This signaling is important so that the serving AP will not keep attempting to deliver any remaining buffered DL data to the client device 110, which may lead to inefficient use of the channel resource. Instead, the serving AP can allocate channel access time to other STAs, providing more efficient use of channel.

When the client device 110 signals to inform the serving AP that it will not be receiving buffered DL data any more from the serving AP, the client device 110 can perform the signaling using one of several mechanisms. In one embodiment, the client device 110 can signal by deleting the links with the serving AP when it is no longer interested in receiving any more buffered DL data across all TIDs. For example, the client device 110 sends a Link Reconfiguration Request frame and signals deletion of all links with the serving AP. In other embodiments, the client device 110 may send a frame such as a Link Reconfiguration Notify frame to signal end of buffered DL draining with the serving AP. The indication in frame can be provided at the per-TID/per-AC level or even per SCS ID level, indicating for which types of flows client device is signaling end of buffered DL draining with the serving AP. This granular signaling enables the client device 110 to terminate draining for specific flows while continuing to receive buffered data for other flows.

In other embodiments, the client device 110 sends a Block Acknowledge (BA) frame, including an indication that the client device 110 is not interested in receiving further buffered DL data for a specific TID indicated in the BA frame or all TIDs. This can be implemented by using a reserved bit in the BA Control field or by using another field/subfield in the BA frame. The BA frame approach allows the client device 110 to provide the indication while acknowledging received data, enabling efficient signaling without requiring a separate management frame.

In some embodiments, the client device 110 sends a QoS Null UL frame that signals in an A-Control field that the client device 110 is not interested in receiving buffered DL data. The indication in the A-Control can be provided at the per-TID/per-AC level or even per SCS ID level. This granular signaling enables the client device 110 to terminate draining for specific flows while continuing to receive buffered data for other flows.

In certain embodiments, the client device 110 sends a Multi-STA BA, where a new type of per-AID TID Info field or a new feedback type in the Per-AID TID Info field can be defined for signaling that the client device 110 does not want to receive any remaining buffered DL data. The indication can be at a per-TID, per-AC, or per-SCS stream level. The fields in this new Per AID TID Info can be used to indicate the client device 110 is not interested in continuing to receive buffered DL data.

In general, when the client device 110 is done fetching buffered DL data, the client device 110 can delete links with the serving AP using the Link Reconfiguration Request/Response exchange. However, the client device 110 may not be able to perform this step based on its RSSI conditions and client implementation. The serving AP will automatically delete the links for the client device 110 if it receives the indication from the client device 110 that it is not interested in more DL PPDUs from serving AP or based on a default timer.

In certain embodiments, all of the buffered DL data may be delivered to the client device before expiration of the buffered DL data delivery period. To enable the client device 110 to then fully transition to the target AP, the serving AP can also signal to the client device 110 when it has completed delivery of all buffered DL data. This signaling enables the client device 110 to know that no additional data remains at the serving AP and that it can safely delete links with the serving AP and fully transition to the target AP.

In one embodiment, when the serving AP is done with delivery of buffered DL data, it can send a Link Reconfiguration Notify frame to the client device 110 indicating to delete the links with the serving AP. The Link Reconfiguration Notify frame provides explicit signaling that the serving AP has no more buffered data to deliver and is initiating link deletion.

Alternatively, the serving AP can signal that it has no more buffered data by indicating an empty Buffer Status Report (BSR) to the client device 110. The serving AP can also signal the remaining Queue Size in the last few MPDUs transmitted to the client device 110, enabling the client device 110 to determine when all buffered data has been received. For example, the serving AP can include Queue Size information in an A-Control field or other signaling mechanism in DL MPDUs, with the Queue Size decreasing as buffered data is transmitted and reaching zero when all buffered data has been delivered. The client device 110 can monitor this Queue Size signaling to determine when buffered data delivery is complete and can then delete links with the serving AP.

### Client Behavior When Receiving Buffered DL Data

For seamless roaming, after the roaming execution exchange is completed, the client device 110 can switch its radio resources between the current serving AP and the target AP. This behavior typically depends on the radio capability of the client device 110. For example, a single radio client device 110 can switch its radio resources back and forth between serving AP and target AP. A multi-radio capable client device 110 may keep one or more radios connected to the serving AP to fetch buffered DL data and can switch other radio resources to the target AP to perform UL and DL exchange with target AP.

When the client device 110 is switching its radio resources from the serving AP to the target AP, it needs to signal to the serving AP that those links are not available for buffered DL data delivery any more. The client device 110 sends a frame signaling PM=1 for the one or more links that will no longer be available with the serving AP. For example, the client device 110 sends a QoS Null frame with PM=1 to the serving AP. The client device 110 may not send UL data to the serving AP after roaming execution, but the client device 110 should send a QoS Null frame indicating PM=1 to the serving AP for the links which are not available for buffered DL data delivery. The client device 110 can use cross-link PM indication (as defined in IEEE 802.11bn) to signal one or more links that will not be available for buffered DL data delivery.

When the client device 110 switches back some of its radio resources from target AP back to the serving AP, then it should send another QoS Null with PM=0, to signal availability of one or more links for receiving buffered DL data. The client device 110 can use cross-link PM indication in QoS Null to signal availability of multiple links for buffered DL data fetch.

In one embodiment, the client device 110 can piggyback the indication of a link not being available any more for buffered DL data delivery (temporarily) using an indication in the BA frame sent to the serving AP. For example, this can be done using some reserved bits in the BA Control. In one embodiment, this can also be an indication sent in Multi-STA Block Ack to the serving AP.

Some client devices 110 may implement sequential data retrieval, where the client device 110 first receives all the data it wants to or can receive (based on its radio conditions) from the serving AP and then it transitions its radio resources to the target AP and performs DL and UL data exchange with the target AP. Such a client device 110 may need to signal to the serving AP that it is no longer available for receiving DL data delivery when it switches its radios to the target AP. The client device 110 can either delete the links with the serving AP or provide such signaling in the last BA/Multi-STA frame sent to the serving AP. The serving AP may then stop delivering any buffered DL data to the client device 110.

Such a client device 110 can also signal in the roaming execution request that it supports sequential data retrieval from the serving AP first and then from the target AP. In this case, if the serving AP is not able to deliver some MPDUs to the client device 110 after a small number of tries, it can assume that the client device 110 has moved on to the target AP and then stop attempts for DL data delivery. This capability signaling enables the serving AP to adapt its retry behavior for sequential data retrieval clients, avoiding excessive retransmission attempts when the client has already transitioned to the target AP.

### Buffered DL Data Forwarding Example Signaling

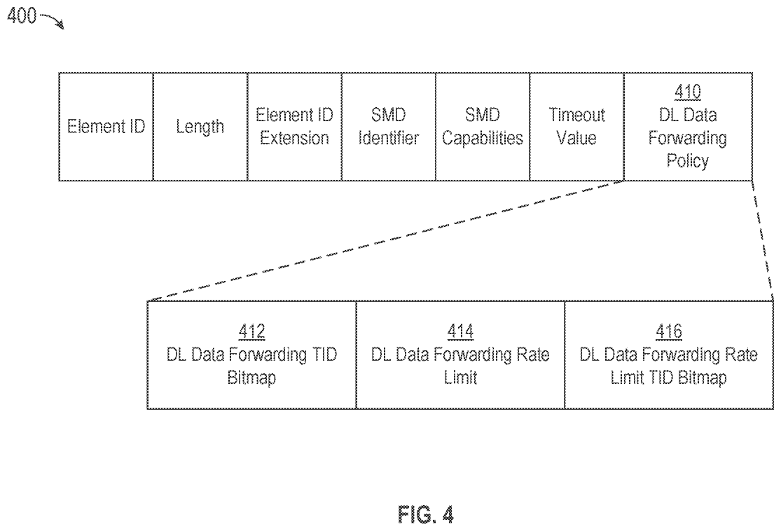

FIG. 4 is a block diagram illustrating an example SMD information element 400 for DL data forwarding capability and policy advertisement. The SMD information element 400 illustrates enhancements to SMD information elements or other elements for signaling buffered DL data forwarding capabilities and policies that enable client devices to formulate appropriate preferences for data forwarding.

Data forwarding is an optional capability that may be supported by APs within an SMD. APs can advertise whether they support data forwarding and, if supported, can advertise their data forwarding policy and capability to enable client devices to understand what forwarding options are available. The SMD information element 400 or another element can be used to provide SMD/AP side policy for DL data forwarding. The DL forwarding policy can be indicated per TID or per AC.

In the illustrated embodiment, the SMD information element 400 includes a presence bit to indicate if a DL Data Forwarding Policy field 410 is included. The DL Data Forwarding Policy field 410 can be part of an SMD Capabilities field (e.g., with the size of SMD Capabilities field increased to be 2 or 3 octets), or the DL Data Forwarding Policy field 410 can be added as a new field. For example, an SMD control field or presence bitmap field can indicate a present bit for the DL Data Forwarding Policy field 410 and other optional fields.

The DL data forwarding policy field 410 can include a DL Data Forwarding TID bitmap 412, where a bit is set to a first value (e.g., 1) if the SMD/AP supports forwarding or prioritizing data frames for that TID, else set to a second value (e.g., 0). A separate bit can indicate whether all TIDs are supported for forwarding, or this can be the default policy. Alternatively, the DL data forwarding policy field 410 could indicate the forwarding policy per AC (e.g., using 4 bits, one for each AC). DL data forwarding may be performed on best effort by the serving AP, or the AP may provide guaranteed forwarding for certain TIDs.

The DL data forwarding policy field 410 can also indicate that certain TIDs/ACs are prioritized for DL data forwarding. Additionally, the DL data forwarding policy field 410 in the SMD Information element 400 can specify whether MSDUs, A-MSDUs, MPDUs, or A-MPDUs can be forwarded, enabling clients to understand what types of data units are eligible for forwarding.

The SMD and/or serving AP may also apply rate limits for the amount of data that it supports for DL data forwarding to target AP for a client device. This limit could be an overall limit per client device 110, a per TID limit, or a per AC limit (e.g., different limits for video TIDs 4 and 5 than voice TIDs 6 and 7). There could also be an overall limit across all the clients between APs. The limits can be advertised via SMD Information element 400. For example, a DL data forwarding rate limit field 414 indicates whether a limit is applied overall, and/or a DL data forwarding rate limit TID bitmap 416 indicates whether DL data forwarding rate limit is applied for one or more TIDs. The field can be defined in an inverse way where 1 represents that AP does not apply rate limit for a TID.

In certain embodiments, the SMD and/or serving AP may signal to client devices that it applies some rate limit for DL data forwarding as part of DL Data forwarding policy in the SMD Information element 400 without indicating any specific limits. In some implementations, for any AP policy for DL data forwarding, these policies can be defined using management and information base (MIB) variables without sending policy to the clients.

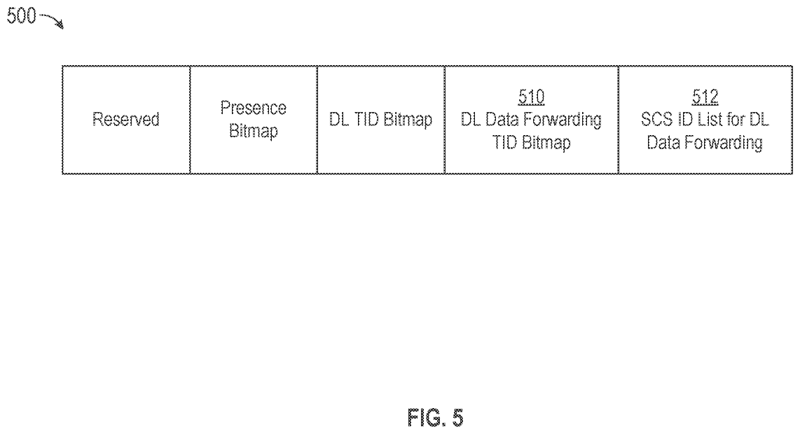

FIG. 5 is a block diagram illustrating an example ST info field 500 in an ST execution request or ST preparation request for DL data forwarding preferences. If an AP advertises any DL data forwarding policy (e.g., per TID based policy for DL data forwarding and/or any rate limiting policy in SMD Information element 400), the client device 110 may indicate whether it prefers to prioritize forwarding of DL data for certain TIDs, ACs, or flows (e.g., SCS flows), for example using the ST info field 500. In some embodiments, the client device 110 can request its preference for prioritizing forwarding of buffered DL data for certain TIDs (or ACs or SCS flows) even without the AP indicating any DL data forwarding policy.

Indicating forwarding preferences may be desirable for the client device 110 if it has multiple TIDs/flows active and some of those flows are more critical for the client device 110. Thus, the client device 110 can indicate forwarding preferences to prioritize data forwarding for the prioritized data. In example implementations, the AP may indicate a capability that the AP supports prioritizing TIDs, ACs, SCS flows for DL data forwarding. This can be defined as a new single bit field in an SMD Information element 400 (when DL Data Forwarding is supported). The client device 110 may only request prioritizing TIDs, ACs, flows, etc. for DL data forwarding if AP indicates this capability.

The set of TIDs, ACs or SCS IDs that are preferred for DL data forwarding can be indicated by the client device 110 in the ST execution request using a DL Data Forwarding TID Bitmap 510 and/or an SCS ID List for DL Data Forwarding field 512. In some embodiments, the client device 110 may indicate TIDs or SCS IDs in a preference order that is desired for DL data forwarding. In this case, TIDs can be signaled using a list of TIDs with higher preference TIDs listed first (or in reverse order) or by indicating a preference field for each TID. In some embodiments, the client device 110 may indicate set of ACs that are preferred for DL data forwarding using a DL data forwarding ACs bitmap field (not shown in FIG. 5).

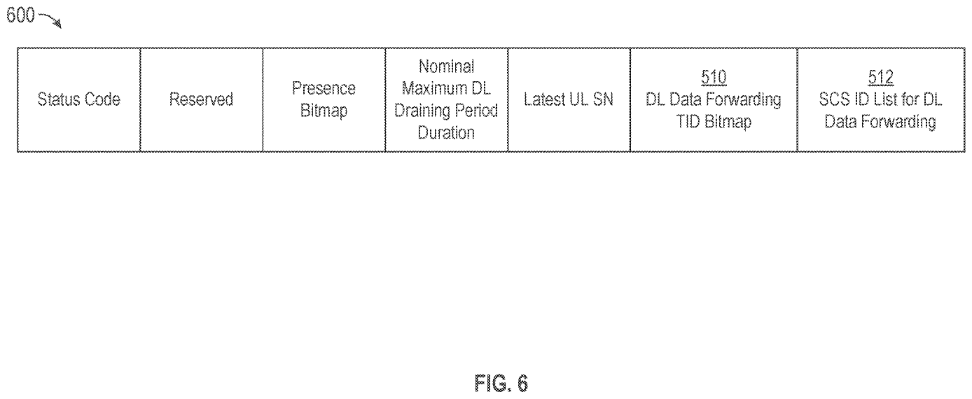

FIG. 6 is a block diagram illustrating an example ST info field 600 in an ST execution response or ST preparation response for DL data forwarding. In the ST execution response, if no additional information is provided by the AP, the default behavior is that the AP will consider client device preferences when forwarding DL data. The forwarding of DL data by the AP may be defined as best effort and may not be guaranteed for all flows.

In the ST execution response, the AP may indicate the set of TIDs and/or set of SCS IDs for which it will try to forward buffered DL data to the target AP (e.g., using a DL Data Forwarding TID Bitmap 610 and/or an SCS ID List for DL Data Forwarding field 612 or DL data forwarding ACs bitmap field (not shown)). This can help the client device 110 to determine when it can terminate its DL data drain and fully move to target AP.

In some embodiments, the serving AP may indicate that it will forward DL data for a set of TIDs, SCS IDs, or ACs that is different than what was requested by the client device 110 (e.g., could be a subset of client requested set or a different set). The serving AP will try to drain rest of the data to the client device 110. The serving AP may indicate the set of TIDs, SCS IDs, or ACs that it will forward data even without the client device 110 indicating a preference to forward specific TIDs, ACs, or SCS IDs in some implementations.

For certain TIDs, ACs, or SCS IDs (e.g., for business-critical flows), the serving AP can indicate guaranteed DL data forwarding in the ST execution response or ST preparation response to achieve zero packet loss. These may be one or more TIDs, ACs, or SCS IDs that the serving AP considers to be high priority/critical or the TIDs, ACs, or SCS IDs that client device 110 has indicated as preferred TIDs for DL data forwarding. In some implementations, this can be signaled by adding another field for such TIDs, ACs, or SCS IDs, such as a Guaranteed DL Data Forwarding TID Bitmap or similar field (also can indicate this for guaranteed DL data forwarding for some ACs or SCS IDs too).

In some embodiments, any TIDs/AC/SCS IDs indicated by the AP in ST execution response is interpreted as AP providing guaranteed DL data forwarding only for those TIDs/ACs/SCS IDs. For all other TIDs/ACs/SCS IDs, AP will provide best effort DL data forwarding. In some embodiments, the serving AP indicates separate TID sets for guaranteed DL data forwarding and/or best effort DL data forwarding. In example implementations, any indicated TIDs, ACs, or SCS IDs in the ST execution response or ST preparation response will be forwarded as best effort.

In some cases, even if the AP supports DL data forwarding, it may not be able to forward DL data in all situations due to backhaul congestion, target AP limitations, or other factors. In the ST execution request or ST preparation request, the client device 110 may request whether the AP forwards DL data to the target AP (and request information on which TIDs or SCS IDs may be forwarded). Then in the ST execution response or ST preparation response, the AP may indicate that it will attempt try to forward DL data for the client device 110 (plus TIDs or SCS IDs). If no such indication is provided, then it may be interpreted that the AP may not forward DL data to the target AP.

In some embodiments, the client device 110 may prefer not to forward any DL data to the target AP, to avoid backhaul delays, and just resume DL data directly received at the target AP from the DS. In this case, in the ST execution request, the client device 110 can indicate that it prefers that no data is forwarded, and the AP either follows that preference and does not forward any data, or the AP confirms in the ST execution response its behavior (of not forwarding or forwarding DL data).

In some embodiments, this signaling for not forwarding DL data can be per-TID specific, and the client device 110 may signal its request to not forward DL data only for certain TIDs (or flows/SCS IDs). This can be for flows where it may be too late to receive forwarded data (e.g., due to added backhaul latency) or where the upper layer application can handle some data loss well. This can be requested in the ST execution request (or ST preparation request) and the AP can accept or reject in the corresponding response. In some embodiments, the AP may still decide to forward DL data for certain TIDs/flows if those flows are considered business critical and need to achieve minimal roaming data loss. In the response, the AP may signal for which TIDs/flows it has accepted the client's request for not forwarding DL data, may indicate the set of TIDs/flows which will not be forwarded, or may indicate the inverse (TIDs/flows that it will try to forward).

The previously mentioned enhancements related to DL data forwarding preferences or negotiation can be exchanged between the client device 110 and serving AP, or between the client device 110 and a target AP, when the client device 110 is performing roaming through a target AP. These DL data forwarding enhancements can be exchanged in any management/action frames. For example, these exchanges can be performed in ST execution request/response, ST preparation request/response, SCS Request/Response frames, (Re)Association Request/Response, or another set of management/action frames. New fields defined can be part of existing elements, subelements, or fields or can be defined as new elements, subelements, or fields.

### DL Data Forwarding Timeout

In some embodiments, the AP may have a timeout duration defined for DL data forwarding, which indicates the amount of time for which the serving AP will try to forward DL data to the target AP. A timeout duration may be defined for DL data forwarding using a MIB variable, and a default value can be defined. This DL data forwarding timeout duration can be provided to the client device 110 in the ST execution response frame. In some embodiments, this timeout is only provided if requested by the client device 110 (e.g., in ST execution request). Otherwise, the timeout is an internal parameter within the serving AP. The timeout value may start from the time the client device 110 receives the ST execution response frame with this timeout value. The serving AP and target AP may account for some variability or time margin when determining the end of timeout value to account for channel access/OTA transmission delay or backhaul transmission delay. In some embodiments, this DL data forwarding timeout can be an SMD wide parameter that is advertised by the APs in the SMD, e.g. in the SMD Information element or another element. This behavior of advertising an SMD wide common value can also be applied for timeout value defined for DL data drain (e.g., the buffered DL data delivery period).

In some embodiments, this DL data forwarding timeout duration can be the same as the duration defined for DL data drain (e.g., the buffered DL data delivery period). Then, a single timeout duration for both DL data drain and DL data forwarding may be used, and the single timeout duration may be provided in the ST execution response to the client device 110. A single MIB parameter may be defined for timeout duration for DL data drain and DL data forwarding or can define separate MIB parameters for DL data drain and DL data forwarding.

If the client device 110 wants DL data forwarding to end earlier than the timeout indicated, then the client device 110 can send a request to the target AP for early termination of DL data forwarding. For example, the client device 110 can send a Link Reconfiguration Notify frame (or another frame) with a Type value or another field indicating early termination of DL data forwarding. After receiving such a request from the client device 110, the target AP may not accept any more DL data from the old serving AP and will switch to only receiving DL data from the DS. The target AP may notify the serving AP to not forward any more DL data (overall or per TIDs).

In some embodiments, a request for early termination of DL data forwarding can be indicated per TID, and the target AP terminates receiving any DL data only for those TIDs from the old AP. This allows shortening the DL data forwarding duration if the client device 110 prefers not to wait for DL data from the serving AP (e.g., to avoid backhaul delays), or if it is too late to receive those DL data frames.

In some embodiments, the client device 110 may send early termination of DL data forwarding indication (either overall or per TID basis) to the serving AP, for example in a Link Reconfiguration Notify frame. Then the serving AP will stop forwarding DL data to the target AP per such a request and also notify the target AP of early termination.

### Buffered DL Data Drain Example Signaling

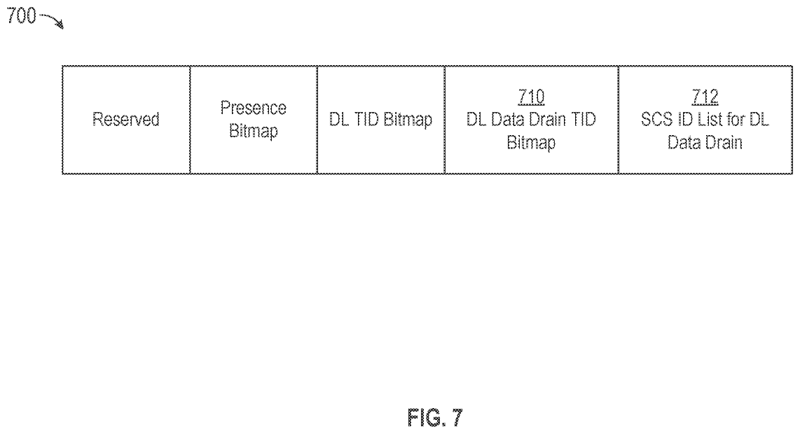

FIG. 7 is a block diagram illustrating an example ST info field 700 in an ST execution request or ST preparation request for DL data drain preferences. By default, the serving AP may support draining buffered DL data to the client device 110 for all TIDs, as long as the client device 110 is available to retrieve the data. The AP can drain buffered DL data to the client device 110 on any of the links for which the client device 110 has signaled not in power save mode (PM=0). For example, a 2.4 GHz or a 5 GHz link may have better RSSI with the serving AP than a 6 GHz link due to longer range characteristics. Hence, the client device 110 may signal PM=0 on one of those links and the serving AP may deliver buffered DL data on the indicated link(s). If the client device 110 is a multi-radio client, the client device 110 can come out of power save on multiple links to receive all the buffered DL data faster across multiple links.

In some embodiments, when the client device 110 is moving, its RSSI is degrading with the serving AP. Thus, the client device 110 may be able to drain only a limited amount of data. The client device 110 may prioritize draining of buffered DL data for TIDs and/or flows which are more critical for the client device 110. For example, the client device 110 may indicate to first drain buffered DL data for TIDs 6 and 7 (e.g., voice TIDs). The AP may then prioritize draining the TIDs indicated by the client device 110.

The client device 110 may indicate in the ST execution request, using the ST info field 700, the set of TIDs, SCS IDs, and/or ACs that it wants to be prioritized for DL data drain by the serving AP, for example using a DL Data Drain TID Bitmap 710 and/or an SCS ID List for DL Data Drain field 712. This can be accepted or rejected by the AP based on policy, implementation, or network conditions, in the ST execution response or ST preparation response. The AP may try to drain DL data for other TIDs as well, if client link(s) are available for draining.

In some embodiments, the client device 110 may indicate that it does not want to drain any DL data, especially when DL data forwarding is supported by the SMD/AP. The client device 110 can therefore to transition to the target AP faster, and resume its UL data transmission sooner, which is desirable. In the ST execution request, the client device 110 can indicate that it prefers to drain DL data or not drain DL data. For example, this can be signaled using a bit “DL Data Drain Not Needed” 720 in the request frame (e.g., in the Presence Bitmap field or another field). By default, this bit is set to a value such as 0, implying that DL data drain will be done. This signaling can be provided when the client device 110 sends an ST execution request directly to target AP as well. Inverse signaling is also possible, where the client device 110 indicates that it prefers to perform DL data drain.

If the client device 110 indicates that it does not need DL data drain, then no DL Draining Period duration is included in the ST execution response, or it is set to zero. Then the serving AP does not try to drain any DL data to the client device 110 after sending ST execution response. The client device 110 can also indicate no DL Data Drain needed when it is performing roaming through target AP, indicating that the client device 110 does not plan to perform DL data drain by going back to old AP. In this case, the target AP can notify the old serving AP of the same, and the old AP will not try to drain DL data to the client device 110. This can save unnecessary tries from the AP to drain DL data, while the client device 110 is not listening for that data.

Any signaling related to DL data drain can apply for when the client device 110 is performing roaming execution through serving AP or through the target AP. Along with indicating no DL data drain, the client device 110 may indicate that the client device 110 wants DL data for all or certain TIDs/SCS IDs to be forwarded to the target AP. Then the client device 110 may include set of TIDs/SCS IDs list for which the client device 110 prefers DL data to be forwarded. In some embodiments, the client device 110 only signals that DL Data drain is not needed if the AP supports DL data forwarding, so as to avoid data loss during roaming.

The DL data drain preferences or negotiation can be exchanged between the client device 110 and serving AP or between the client device 110 and a target AP, when the client device 110 is performing roaming through a target AP. These enhancements can be exchanged in any management/action frames. For example, these exchanges can be performed in ST execution request/response, ST preparation request/response, SCS Request/Response frames, (Re)Association Request/Response exchange, or another set of management/action frames. New fields defined can be part of existing elements, subelements, or fields or can be defined as new elements, subelements, or fields.

When the client device 110 is roaming through a target AP, and the client device 110 still performs DL data drain through the serving AP, the client device 110 can send a separate action frame to the serving AP to specify any preferences for DL data drain (e.g., prioritize certain TIDs, flows etc.). In some embodiments, this can be sent in a Link Reconfiguration Notify frame (or another frame) to the serving AP, with an existing Type value or a new Type value or a new field, and by including a field/element/subelement providing any preferences for DL data drain. It can include an SMD BSS Transition Parameter element providing this information. Alternatively, the client device 110 provides its preference to target AP, and the target AP sends the client's preference to the serving AP. The set of TIDs in any of the frames can be indicated using a TID bitmap or using set of TID values in a preference order.

### Further Logic for DL Data Handling

The serving AP can support DL data drain when the client device 110 is roaming through serving AP or through a target AP. The AP may have a policy to prioritize DL data drain for certain TIDs or SCS IDs, for example for TIDs/flows that are critical or more important. This can be internal policy at the AP/SMD, without indicating this to client devices.

The AP side policy for DL data drain can include: ACs, TIDs, or SCS IDs which are prioritized first for DL data drain; any specific retry limit on DL data drain (e.g., the AP may have a different and shorter retry count for DL data drain than typical data frame retry count, given that the client device 110 is moving away and it may be wasting airtime to keep retrying for long); and stopping DL data drain to the client device 110 after a certain number of transmission failures for DL data frames (e.g., when no Ack received). These policies may be defined for the AP to follow for DL data drain (e.g., using MIB variables).

In some embodiments, the AP may advertise its policy for DL data drain to the clients, for example indicating the set of TIDs/ACs that it will prioritize for DL data drain, in the SMD Information element. This can help the client device 110 to map its critical flows to these TIDs, so that critical flows are prioritized in DL data drain. In some embodiments, the AP may indicate to the client device 110 a capability that it supports prioritizing DL data drain based on TIDs, ACs, and/or SCS IDs and can accept preferences from the client device 110 for the same. Then if the AP indicates this capability, the client device 110 can indicate its preference/request to AP to prioritize DL data drain for some set of TIDs, ACs, and/or SCS IDs, which the AP can accept or reject in the response.

In some embodiments, the AP can signal to clients that it provides prioritized DL data draining for ‘low-latency traffic/flows/TIDs’ as a capability/service in the SMD Information element. Then the client device 110 can request such prioritized draining for a specific SMD roaming (either in ST preparation request or ST execution request) and the AP can accept, reject, or confirm in the response. The exact set of flows/TIDs that get prioritized by the AP for DL data drain in this case is left up to the AP to determine, keeping in mind to prioritize low-latency flows. In some embodiments, the client device 110 can indicate a set of TIDs for which it wants low-latency DL data drain in ST execution request and the AP can accept or reject in the response.

In some embodiments, a similar capability for prioritizing low-latency traffic for DL data forwarding can be signaled by the AP, and then the client device 110 can request to prioritize for low-latency traffic for DL data forwarding as well. The set of flows that get prioritized for DL data forwarding are determined by the AP in this case, where it tries to prioritize low-latency flows. In some embodiments, the client device 110 can indicate a set of TIDs/flows that it wants to be prioritized for low-latency DL data forwarding. A single capability can be signaled for prioritizing low-latency flows for both DL data drain and DL data forwarding (e.g., Low Latency DL Data Handling Supported), or separate capabilities can be signaled for the DL data drain and DL data forwarding.

In some embodiments, the AP's default behavior for DL data drain or DL data forwarding may be to prioritize low-latency TIDs/flows. The AP can also accept prioritization requests for TIDs/ACs/SCS IDs from the client device 110 in ST execution request if a capability is defined for that.

The AP may also signal that it can provide zero packet loss for some TIDs as a capability in the SMD Information element. There can be a limit of how many TIDs/flows this can be provided, and the AP can signal that as well, along with any policy on set of TIDs for which this ‘zero packet loss’ service can be provided. For example, the AP can signal that it can provide zero packet loss for TIDs 4 and 5, or at maximum for 2 negotiated TIDs. The AP can define that zero packet loss service may be provided within some DL data forwarding time limits, to ensure that this is achieved within a reasonable time limit. This time limit can be indicated as part of the policy.

The client device 110 can request in the ST execution request (or ST preparation request) for some TIDs/flows (following AP defined policy) for which it desires ‘zero packet loss’ service. Then the AP can indicate in the response the set of TIDs/flows for which it can provide ‘zero packet loss’ service. This can be the same set, a subset, or a different set of TIDs than requested by the client device 110. The AP can on its own determine to provide zero packet loss for some TIDs/flows during SMD roaming, for example for some TIDs/critical flows. The AP can signal this to the client device 110 in the ST execution response. The AP can then attempt to drain data for those TIDs/flows indicated for zero packet loss and forward remaining data for those TIDs to the target AP. For other TIDs/flows, the AP performs best effort to drain and/or forward DL data.

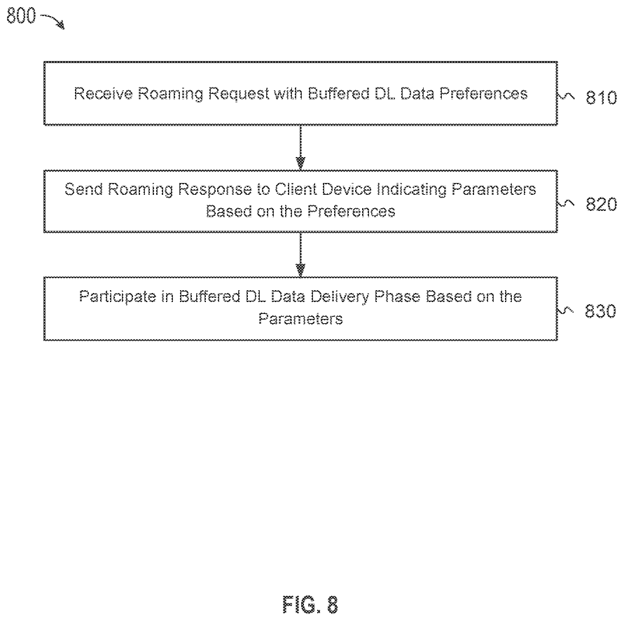

FIG. 8 is a flowchart illustrating a method 800 for handling buffered DL data during seamless roaming from a serving AP perspective. The method 800 enables a serving AP MLD to receive client preferences for buffered DL data handling and to deliver or forward buffered DL data based on negotiated parameters during a buffered DL data delivery phase.

At stage 810, the serving AP MLD receives a roaming request from a client device. The roaming request indicates an intent to roam from the serving AP to a target AP and includes one or more preferences for handling buffered DL data at the serving AP. The one or more preferences may indicate at least one of: a set of TIDs for which buffered DL data handling is preferred, a set of ACs for which buffered DL data handling is preferred, or a set of SCS identifiers for which buffered DL data handling is preferred. The one or more preferences may indicate at least one of: a preference to drain all buffered DL data, a preference to receive the buffered DL data only for one or more ACs, TIDs, or SCS streams, a preference to drain buffered DL data that cannot be forwarded to the target AP, a preference to drain buffered DL data for one or more ACs, TIDs, or SCS streams that cannot be forwarded to the target AP, a preference to receive only buffered DL data that has been unsuccessfully transmitted, or a preference not to receive buffered DL data. The one or more preferences may comprise an indication to deliver the buffered DL data on a plurality of links.

At stage 820, the serving AP MLD sends a roaming response to the client device. The roaming response indicates parameters for delivering buffered DL data based on the one or more preferences. The parameters may include a set of TIDs, ACs, or SCS identifiers for which buffered DL data will be delivered or forwarded, a set of links on which buffered DL data will be delivered, and a duration for the buffered DL data delivery phase.

At stage 830, the serving AP MLD participates in a buffered DL data delivery phase with the client device based on the parameters indicated in the roaming response. Participating in the buffered DL data delivery phase includes delivering at least a first portion of the buffered DL data to the client device or forwarding at least a second portion of the buffered DL data to the target AP. Where the one or more preferences comprise an indication to deliver the buffered DL data on a plurality of links, the serving AP MLD delivers the buffered DL data to the client device on the plurality of links.

During the buffered DL data delivery phase, the serving AP MLD may receive a first frame from the client device indicating that one or more first links are entering a power save mode and are not available for receiving buffered DL data. In response to receiving the first frame, the serving AP MLD ceases delivery of buffered DL data on the one or more first links. The serving AP MLD may subsequently receive a second frame from the client device indicating that the one or more first links are exiting the power save mode and are available for receiving buffered DL data, and in response to receiving the second frame, resume delivery of buffered DL data to the client device on the one or more first links.

The serving AP MLD may receive an indication from the client device that the client device will not be receiving additional buffered DL data from the serving AP, and in response to receiving the indication, cease attempts to deliver remaining buffered DL data to the client device. The indication may be received via a Link Reconfiguration Request frame, a BA frame, a QoS Null frame with an indication in an A-Control field, or a Multi-STA BA frame.

FIG. 9 is a block diagram of a computing device 900. As shown in FIG. 9, computing device 900 may include a processing unit 910 and a memory unit 915. Memory unit 915 may include a software module 920 and a database 925. While executing on processing unit 910, software module 920 may perform, for example, processes for providing buffer indication signaling for seamless roaming. Computing device 900, for example, may provide an operating environment for the first AP 102, the second AP 104, the SMD-ME 108, the client device 110, the controller 120, and the like. The first AP 102, the second AP 104, the SMD-ME 108, the client device 110, the controller 120, and the like may operate in other environments and are not limited to computing device 900.

Computing device 900 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 900 may comprise any computer operating environment, such as hand-held devices, multiprocessor systems, microprocessor-based or programmable sender electronic devices, minicomputers, mainframe computers, and the like. Computing device 900 may also be practiced in distributed computing environments where tasks are performed by remote processing devices. The aforementioned systems and devices are examples, and computing device 900 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 900 on the single integrated circuit (chip).

FIG. 10 illustrates an implementation of a communications device 1000 that may implement one or more of the first AP 102, the second AP 104, the SMD-ME 108, the client device 110, the controller 120, etc. In various implementations, the communications device 1000 may comprise a logic circuit. The logic circuit may include physical circuits to perform operations described for one or more of the first AP 102, the second AP 104, the SMD-ME 108, the client device 110, the controller 120, etc., for example. As shown in FIG. 10, the communications device 1000 may include one or more of, but is not limited to, a radio interface 1010, baseband circuitry 1030, and/or the computing device 900.

The communications device 1000 may implement some or all of the structures and/or operations for the first AP 102, the second AP 104, the SMD-ME 108, the client device 110, the controller 120, etc., storage medium, and logic circuit in a single computing entity, such as entirely within a single device. Alternatively, the communications device 1000 may distribute portions of the structure and/or operations using a distributed system architecture, such as a client station server architecture, a peer-to-peer architecture, a master-slave architecture, etc.

A radio interface 1010, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 1010 may include, for example, a receiver 1015 and/or a transmitter 1020. The radio interface 1010 may include bias controls, a crystal oscillator, and/or one or more antennas 1025. In additional or alternative configurations, the radio interface 1010 may use oscillators and/or one or more filters, as desired.

The baseband circuitry 1030 may communicate with the radio interface 1010 to process, receive, and/or transmit signals and may include, for example, an Analog-To-Digital Converter (ADC) for down converting received signals with a Digital-To-Analog Converter (DAC) 1035 for up converting signals for transmission. Further, the baseband circuitry 1030 may include a baseband or PHY layer processing circuit for the PHY link layer processing of respective receive/transmit signals. Baseband circuitry 1030 may include, for example, a MAC processing circuit 1040 for MAC/data link layer processing. Baseband circuitry 1030 may include a memory controller for communicating with MAC processing circuit 1040 and/or a computing device 900, for example, via one or more interfaces 1045.

In some configurations, PHY processing circuit may include a frame construction and/or detection module, in combination with additional circuitry such as a buffer memory, to construct and/or deconstruct communication frames. Alternatively or in addition, MAC processing circuit 1040 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
establishing, by an access point (AP) multilink device (MLD), an association between a Seamless Mobility Domain (SMD) management entity (ME) and a non-AP MLD,
wherein the SMD-ME corresponds to an SMD,
wherein the SMD comprises the AP MLD and a second AP MLD,
wherein the association comprises at least one link between a first affiliated AP of the AP MLD and a first STA of the non-AP MLD;
receiving, by the AP MLD, a roaming preparation request from the non-AP MLD, wherein the roaming preparation request includes information indicating a second AP MLD;
transmitting a roaming preparation response to the non-AP MLD, the roaming preparation response including an indication that link resources of the second AP MLD have been reserved for the non-AP MLD;
receiving, by the AP MLD, a roaming execution request from the non-AP MLD, the roaming execution request indicating the second AP MLD;
transmitting, by the AP MLD, a roaming execution response to the non-AP MLD, the roaming execution response indicating a status of the roaming execution and a downlink drain period time defining an expiration of a downlink drain period;
transmitting, by the AP MLD, downlink data to the non-AP MLD during the downlink drain period;
receiving, by the AP MLD, a termination message from the non-AP MLD, the messaging indicating termination of the downlink drain period prior to the expiration of the downlink drain period; and
responsive to the termination message, terminating the downlink drain period.

2. The method of claim 1 further comprising:
responsive to a determination that no more downlink data for the non-AP MLD remains prior to expiration of the downlink drain period, transmitting by the AP MLD, a message including information indicating termination of the downlink drain period.

3. The method of claim 1 wherein the roaming execution request includes information indicating one or more preferences for the downlink drain period.

4. The method of claim 3 wherein at least one preference of the one or more preferences corresponds to a traffic identifier (TID).

5. The method of claim 1 further comprising receiving from the non-AP MLD a wireless frame indicating termination of the downlink drain period prior to the expiration of the downlink drain period; and
terminating the downlink drain period in response to the wireless frame received from the non-AP MLD.

6. The method of claim 1 further comprising sending context information of the association to the second AP MLD.

7. The method of claim 6 wherein the roaming preparation request includes information indicating one or more context transfer preferences, and wherein the context information corresponds to the one or more context transfer preferences.

8. The method of claim 1 further comprising sending context information of the association to the second AP MLD in response to the roaming execution request.

9. The method of claim 1 further comprising deleting the at least one link between a first affiliated AP of the AP MLD and a first STA of the non-AP MLD after termination of the downlink drain period.

10. An access point (AP) multi-link device (MLD) comprising:
one or more affiliated APs;
at least one memory element for storing data; and
at least one processor for executing instructions associated with the data, wherein executing the instructions causes the AP MLD to perform operations, comprising
establishing an association between a Seamless Mobility Domain (SMD) management entity (ME) and a non-AP MLD, wherein the SMD-ME corresponds to an SMD,
wherein the SMD comprises the AP MLD and a second AP MLD,
wherein the association comprises at least one link between a first affiliated AP of the AP MLD and a first STA of the non-AP MLD;
receiving a roaming preparation request from the non-AP MLD, wherein the roaming preparation request includes information indicating a second AP MLD;
transmitting a roaming preparation response to the non-AP MLD, the roaming preparation response including an indication that link resources of the second AP MLD have been reserved for the non-AP MLD;
receiving a roaming execution request from the non-AP MLD, the roaming execution request indicating the second AP MLD;
transmitting a roaming execution response to the non-AP MLD, the roaming execution response indicating a status of the roaming execution and a downlink drain period time defining an expiration of a downlink drain period;
transmitting downlink data to the non-AP MLD during the downlink drain period;
receiving a termination message from the non-AP MLD, the messaging indicating termination of the downlink drain period prior to the expiration of the downlink drain period; and
responsive to the termination message, terminating the downlink drain period.

11. The AP MLD of claim 10, the operations further comprising:
responsive to a determination that no more downlink data for the non-AP MLD remains prior to expiration of the downlink drain period, transmitting by the AP MLD, a message including information indicating termination of the downlink drain period.

12. The AP MLD of claim 10 wherein the roaming execution request includes information indicating one or more preferences for the downlink drain period.

13. The AP MLD of claim 12 wherein at least one preference of the one or more preferences corresponds to a traffic identifier (TID).

14. The AP MLD of claim 10, the operations further comprising receiving from the non-AP MLD a wireless frame indicating termination of the downlink drain period prior to the expiration of the downlink drain period; and
terminating the downlink drain period in response to the wireless frame received from the non-AP MLD.

15. The AP MLD of claim 10, the operations further comprising sending context information of the association to the second AP MLD.

16. The AP MLD of claim 15 wherein the roaming preparation request includes information indicating one or more context transfer preferences, and wherein the context information corresponds to the one or more context transfer preferences.

17. The AP MLD of claim 10, the operations further comprising sending context information of the association to the second AP MLD in response to the roaming execution request.

18. The AP MLD of claim 10, the operations further comprising deleting the at least one link between a first affiliated AP of the AP MLD and a first STA of the non-AP MLD after termination of the downlink drain period.

19. A non-transitory computer readable storage medium comprising instructions that when executed configure one or more processors of an access point (AP) multi-link device (MLD) to perform operations comprising:
establishing an association between a Seamless Mobility Domain (SMD) management entity (ME) and a non-AP MLD, wherein the SMD-ME corresponds to an SMD,
wherein the SMD comprises the AP MLD and a second AP MLD,
wherein the association comprises at least one link between a first affiliated AP of the AP MLD and a first STA of the non-AP MLD;
receiving a roaming preparation request from the non-AP MLD, wherein the roaming preparation request includes information indicating a second AP MLD;
transmitting a roaming preparation response to the non-AP MLD, the roaming preparation response including an indication that link resources of the second AP MLD have been reserved for the non-AP MLD;
receiving a roaming execution request from the non-AP MLD, the roaming execution request indicating the second AP MLD;
transmitting a roaming execution response to the non-AP MLD, the roaming execution response indicating a status of the roaming execution and a downlink drain period time defining an expiration of a downlink drain period;
transmitting downlink data to the non-AP MLD during the downlink drain period;
receiving a termination message from the non-AP MLD, the messaging indicating termination of the downlink drain period prior to the expiration of the downlink drain period; and
responsive to the termination message, terminating the downlink drain period.

20. The non-transitory computer readable storage medium of claim 19, the operations further comprising:
responsive to a determination that no more downlink data for the non-AP MLD remains prior to expiration of the downlink drain period, transmitting by the AP MLD, a message including information indicating termination of the downlink drain period.

21. The non-transitory computer readable storage medium of claim 19 wherein the roaming execution request includes information indicating one or more preferences for the downlink drain period.

22. The non-transitory computer readable storage medium of claim 21 wherein at least one preference of the one or more preferences corresponds to a traffic identifier (TID).

23. The non-transitory computer readable storage medium of claim 19, the operations further comprising receiving from the non-AP MLD a wireless frame indicating termination of the downlink drain period prior to the expiration of the downlink drain period; and
terminating the downlink drain period in response to the wireless frame received from the non-AP MLD.

24. The non-transitory computer readable storage medium of claim 19, the operations further comprising sending context information of the association to the second AP MLD.

25. The non-transitory computer readable storage medium of claim 24 wherein the roaming preparation request includes information indicating one or more context transfer preferences, and wherein the context information corresponds to the one or more context transfer preferences.

26. The non-transitory computer readable storage medium of claim 19, the operations further comprising sending context information of the association to the second AP MLD in response to the roaming execution request.

27. The non-transitory computer readable storage medium of claim 19, the operations further comprising deleting the at least one link between a first affiliated AP of the AP MLD and a first STA of the non-AP MLD after termination of the downlink drain period.
